(19) United States
(12) Patent Application Publication
(10) Pub. No.: US 2020/0332193 A1
(43) Pub. Date: Oct. 22, 2020

(54) LIQUID CRYSTAL ELEMENT USED FOR PHASE CONTROL OF ELECTROMAGNETIC WAVE SIGNAL

(71) Applicants: JNC CORPORATION, Tokyo (JP); JNC PETROCHEMICAL CORPORATION, Tokyo (JP)

(72) Inventors: Norio TAMURA, CHIBA (JP); Yoichi Uriu, CHIBA (JP)

(73) Assignees: JNC CORPORATION, Tokyo (JP); JNC PETROCHEMICAL CORPORATION, Tokyo (JP)

(21) Appl. No.: 16/848,847

(22) Filed: Apr. 15, 2020

(30) Foreign Application Priority Data
Apr. 18, 2019 (JP) 2019-079022

(51) Int. Cl. C09K 19/18; G02F 1/00; G02F 1/1337; C09K 19/30; C09K 19/32; C09K 19/34

(52) U.S. Cl. CPC C09K 19/18; G02F 1/0045; G02F 1/133711; C09K 19/3048; C09K 19/322; C09K 19/3491; C09K 2019/0466; C09K 2019/183; C09K 2019/3056; C09K 2019/188; C09K 2019/186; C09K 2019/3422; C09K 2019/181

(57) ABSTRACT

There is provided an element which has large dielectric anisotropy and low dielectric loss in a high frequency range, has high reliability, and is used for phase control of an electromagnetic wave signal with a frequency of 1 MHz to 400 THz. An element in which a liquid crystal composition contains a compound represented by the following Formula (1) and has a refractive index anisotropy of 0.30 or more at a wavelength of 589 nm, and a polyimide alignment film contains 10% or more of a repeating unit represented by the following Formula (2) with respect to all repeating units:

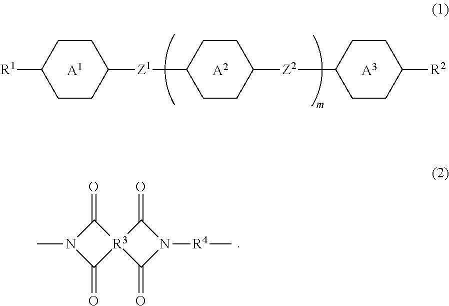

### CROSS-REFERENCE TO RELATED APPLICATIONS

This application claims the priority benefit of Japanese Patent Application No. 2019-079022, filed on Apr. 18, 2019. The entirety of the above-mentioned patent application is hereby incorporated by reference herein and made a part of this specification.

### BACKGROUND

### Technical Field

The disclosure relates to an element used for phase control of an electromagnetic wave signal with a frequency of 1 MHz to 400 THz.

### Description of Related Art

Examples of an element used for phase control of an electromagnetic wave signal with a frequency of 1 MHz to 400 THz include a millimeter wave band antenna, a microwave band antenna, and an infrared laser element. Various methods have been examined for such elements. Among these, a method using liquid crystal, which is thought to have few failures because there is no mechanical movable part, has been focused on.

In liquid crystals, alignment of molecules changes according to a bias electric field from the outside and a dielectric constant changes. When such a property is used, for example, it is possible to realize a microwave device that can electrically control transmission characteristics of a high frequency transmission line from the outside. Regarding such devices, a voltage-controlled millimeter wave band variable phase shifter in which a nematic liquid crystal is filled into a waveguide and a wideband variable phase shifter with a microwave and millimeter wave band in which a nematic liquid crystal is used as a dielectric substrate of a micro strip line have been reported (Patent Documents 1 and 2).

It is desirable for such elements used for phase control of an electromagnetic wave signal to have characteristics such as a wide temperature range in which the element can be used, and large dielectric anisotropy and low dielectric loss in a high frequency range. For example, Patent Document 3 discloses a liquid crystal composition having large refractive index anisotropy in a visible range and low dielectric loss in a high frequency range. In addition, Patent Document 4 discloses that dielectric anisotropy with respect to microwaves has a positive correlation with refractive index anisotropy with respect to visible light.

### PATENT DOCUMENTS

[Patent Document 1] PCT International Publication No. WO2017/201515

[Patent Document 2] United States Patent Publication No. 2018/0239213

[Patent Document 3] Japanese Patent Laid-Open No. 2011-74074

[Patent Document 4] PCT International Publication No. WO2018/079427

### SUMMARY

The disclosure provides an element which has large dielectric anisotropy and low dielectric loss in a high frequency range and has a high voltage holding ratio and is used for phase control of an electromagnetic wave signal with a frequency of 1 MHz to 400 THz.

The inventors found that an element composed of specific materials in combination solves the above problems and completed the disclosure.

The disclosure includes the following aspects.

[1] An element which is used for phase control of an electromagnetic wave signal with a frequency of 1 MHz to 400 THz and in which phase difference control is performed by a liquid crystal composition provided between two substrates, and which includes a polyimide alignment film for alignment control of the liquid crystal composition,

wherein the liquid crystal composition contains a compound represented by the following Formula (1), and has a refractive index anisotropy of 0.30 or more at a wavelength of 589 nm, and

wherein the polyimide alignment film contains 10% or more of a repeating unit represented by the following Formula (2) with respect to all repeating units:

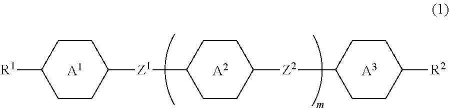

in Formula (1), R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom,

the rings A¹, A² and A³ independently represent one selected from among groups represented by the following Formula (I) to Formula (XXXVI),

Z¹ and Z² independently represent a single bond, —CH₂CH₂—, —CH═CH—, —CF═CF—, —CH═CF—, —CH₂O—, —COO—, —CF₂CF₂—, —C≡C—, —C≡C—C≡C—, or —CF₂O—,

m represents an integer of 0 to 5, and when m is 2 to 5, a plurality of rings A² and Z² may be the same as or different from each other;

R² represents the above R¹, —CN, —F, —Cl, —CF₃, —OCF₃, —CF₂H, —OCF₂H, —NCS, or —SF₅.

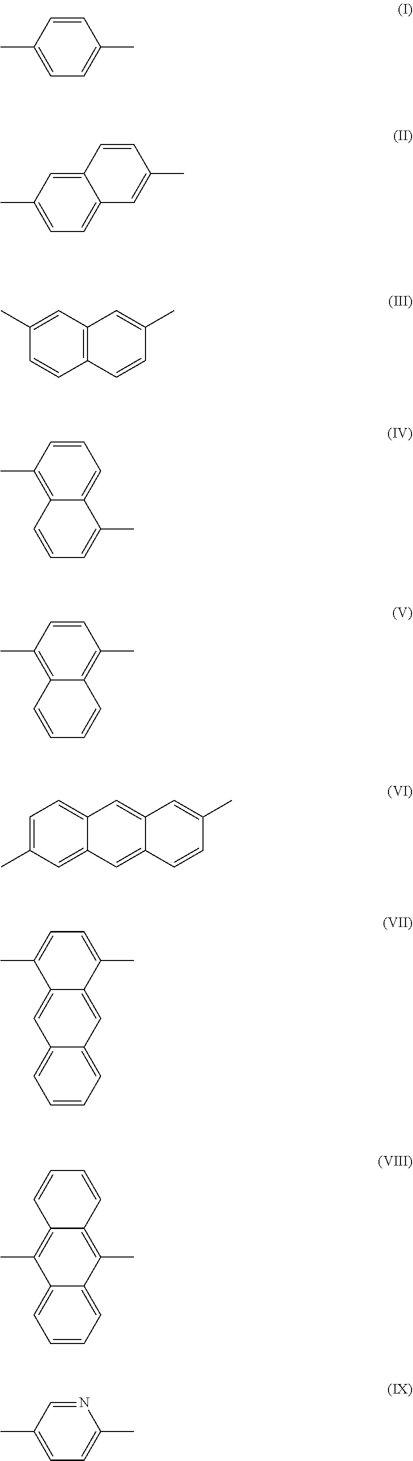

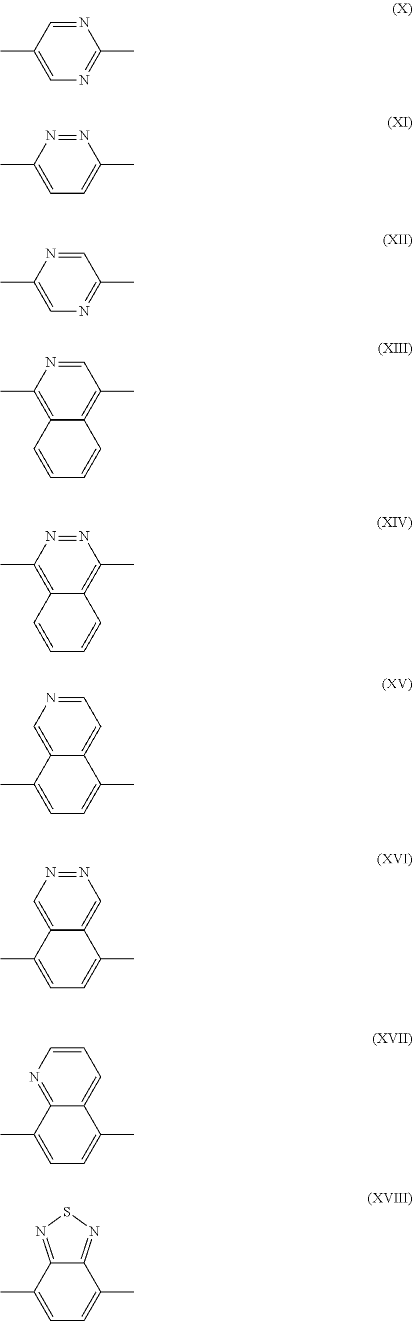

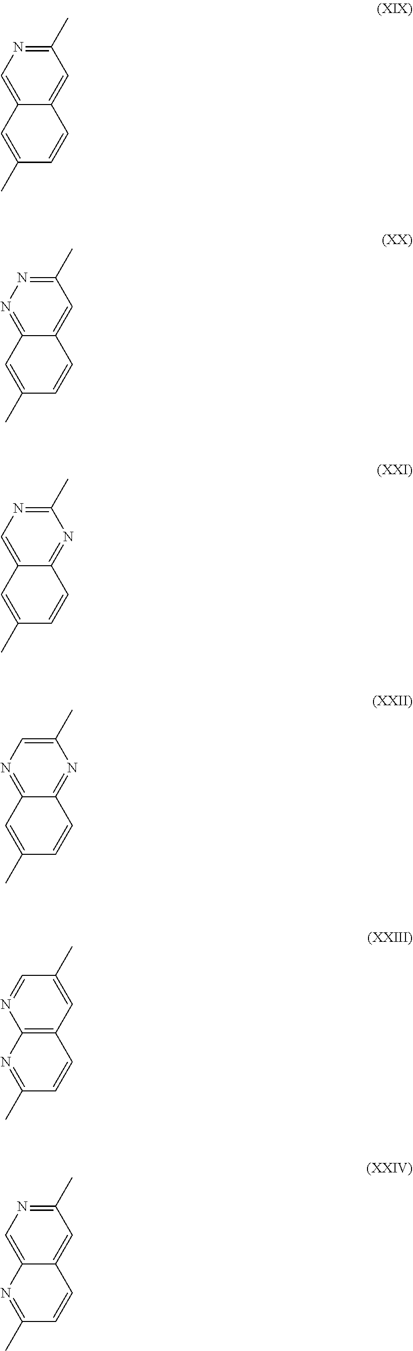

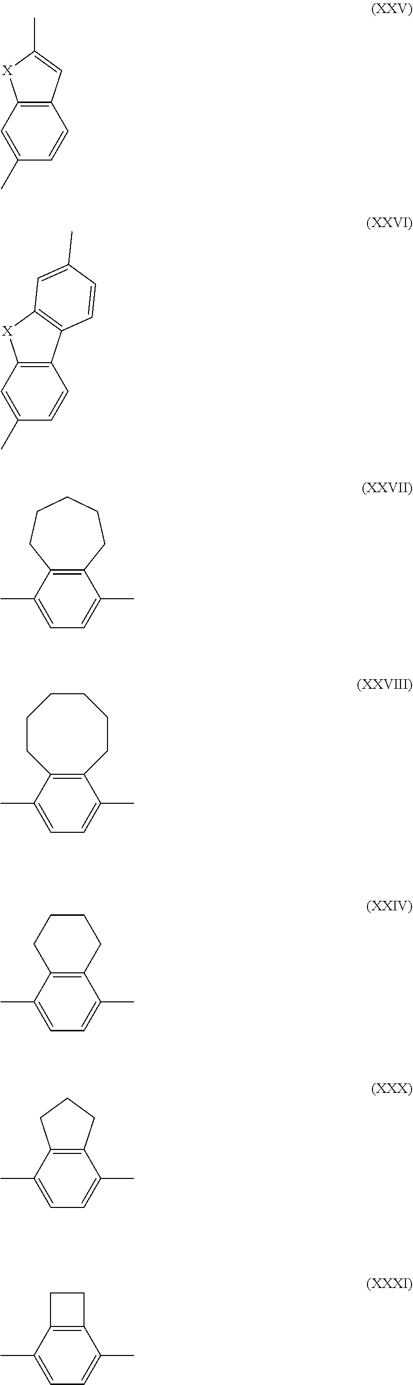

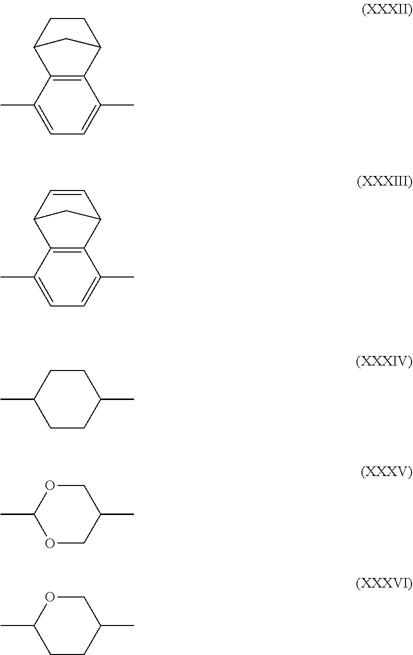

in the groups represented by Formula (I) to Formula (XXXVI), one or more hydrogen atoms may be substituted with a fluorine atom, an alkyl group having 1 to 5 carbon atoms, or a cycloalkyl group having 3 to 6 carbon atoms,

X is —NH— or —S—.

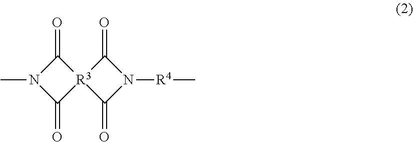

in Formula (2), R³ represents an alicyclic structure, and R⁴ represents a divalent organic group having 2 to 50 carbon atoms.

[2] The element according to [1], wherein R³ in Formula (2) is a group represented by the following Formula (2-1) to Formula (2-3):

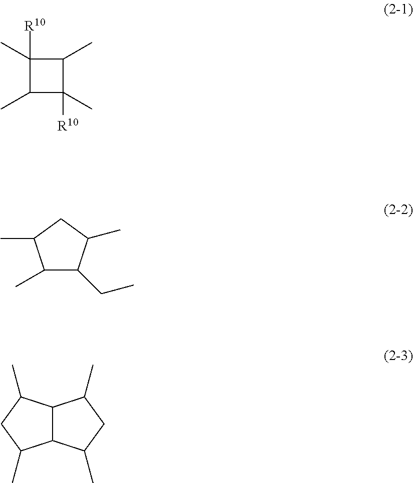

in Formula (2-1), R¹⁰'s each independently represent a hydrogen atom, —CH₃, —CH₂CH₃, or a phenyl group.

[3] The element according to [1] or [2], wherein the compound represented by Formula (1) includes a compound in which Z¹ is —CH═CH—, —CF═CF—, —CH═CF—, —C≡C—, or —C≡C—C≡C—, the rings A¹ and A² are groups represented by Formula (I) to Formula (XXXIII), the ring A³ is a group represented by Formula (I) to Formula (XXXVI), and m represents an integer of 0 to 2.

[4] The element according to any one of [1] to [3], wherein, in the compound represented by Formula (1), one or two selected from among Z¹ and Z² is —CF₂O—, m represents an integer of 0 to 2, and R² is —CN, —F, —CF₃, —OCF₃, —CF₂H, —OCF₂H, —NCS, or —SF₅.

[5] The element according to any one of [1] to [4], wherein the compound represented by Formula (1) includes a compound in which Z¹ and Z² are a single bond, m represents an integer of 0 to 2, and R² is —CN, —F, —CF₃, —OCF₃, —CF₂H, —OCF₂H, —NCS, or —SF₅.

[6] The element according to [1], wherein the compound represented by Formula (1) is a compound represented by the following Formula (1-1):

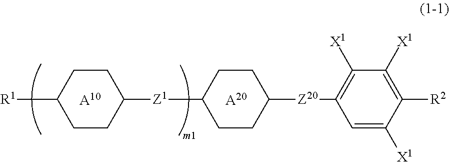

in Formula (1-1), Z¹ represents a single bond, —CH₂CH₂—, —CH═CH—, —CF═CF—, —CH═CF—, —CH₂—, —COO—, —CF₂CF₂—, —C≡C—, —C≡C—C≡C—, or —CF₂—, and Z²⁰ is —C≡C— or —C≡C—C≡C—,

the ring A¹⁰ is a group represented by Formula (I), (II), (V), (VI), (IX), (X), (XI), (XXV), (XXVI), (XXXIV), (XXXV), or (XXXVI), the ring A²⁰ is a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,

R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom;

X¹'s independently represent a hydrogen atom or a fluorine atom,

m1 represents an integer of 0 to 2, and when m1 is 2, a plurality of rings A¹⁰ and Z¹ may be the same as or different from each other; and

R² represents the above R¹, —CN, —F, —Cl, —CF₃, —OCF₃, —CF₂H, —OCF₂H, —NCS, or —SF₅.

[7] The element according to [1], wherein the compound represented by Formula (1) is a compound represented by the following Formula (1-2):

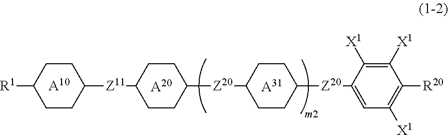

in Formula (1-2), the ring A¹⁰ is a group represented by Formula (I), (II), (V), (VI), (IX), (X), (XI), (XXV), (XXVI), (XXXIV), (XXXV), or (XXXVI), the rings A²⁰ and A³¹ independently represent a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,

Z¹¹ represents a single bond, —CH₂CH₂—, —CH═CH—, —CF═CF—, —CH═CF—, —CH₂O—, —COO—, —CF₂CF₂—, or —C≡C—, Z²⁰ is —CF₂O—, and when there are two or more Z²⁰'s, one is —CF₂O—, and the other represents a single bond, —CH₂CH₂—, —CH═CH—, —CH₂O—, —COO—, —CF₂CF₂—, or —C≡C—,

X¹'s independently represent a hydrogen atom or a fluorine atom,

m2 is 0 or 1,

R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and

R²⁰ is —CN, —F, —Cl, —CF₃, —OCF₃, —CF₂H, —OCF₂H, —NCS, or —SF₅.

[8] The element according to [1], wherein the compound represented by Formula (1) is a compound represented by the following Formula (1-3):

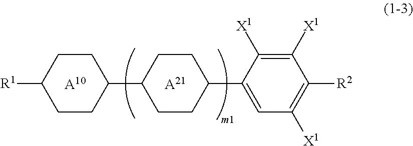

in Formula (1-3), the ring A¹⁰ is a group represented by Formula (I), (II), (V), (VI), (IX), (X), (XI), (XXV), (XXVI), (XXXIV), (XXXV), or (XXXVI), the ring A² is a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,

X¹'s independently represent a hydrogen atom or a fluorine atom,

m1 represents an integer of 0 to 2, and when m1 is 2, a plurality of ring A²¹'s may be the same as or different from each other;

R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and

R² represents the above R¹, —CN, —F, —Cl, —CF₃, —OCF₃, —CF₂H, —OCF₂H, —NCS, or —SF₅.

[9] The element according to [6], wherein the compound represented by Formula (1-1) is one represented by the following Formula (1-1-1) to Formula (1-1-41):

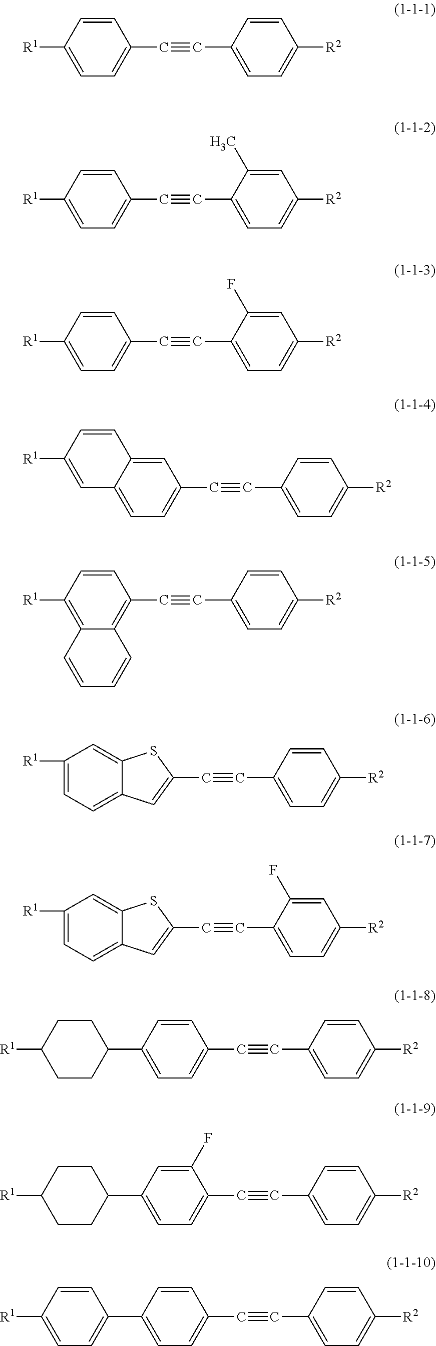

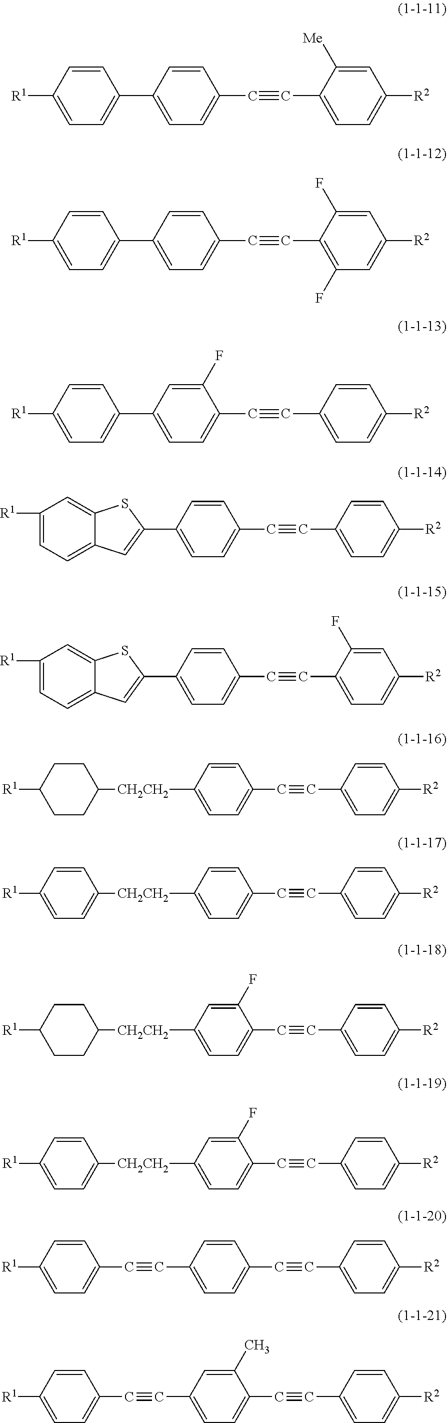

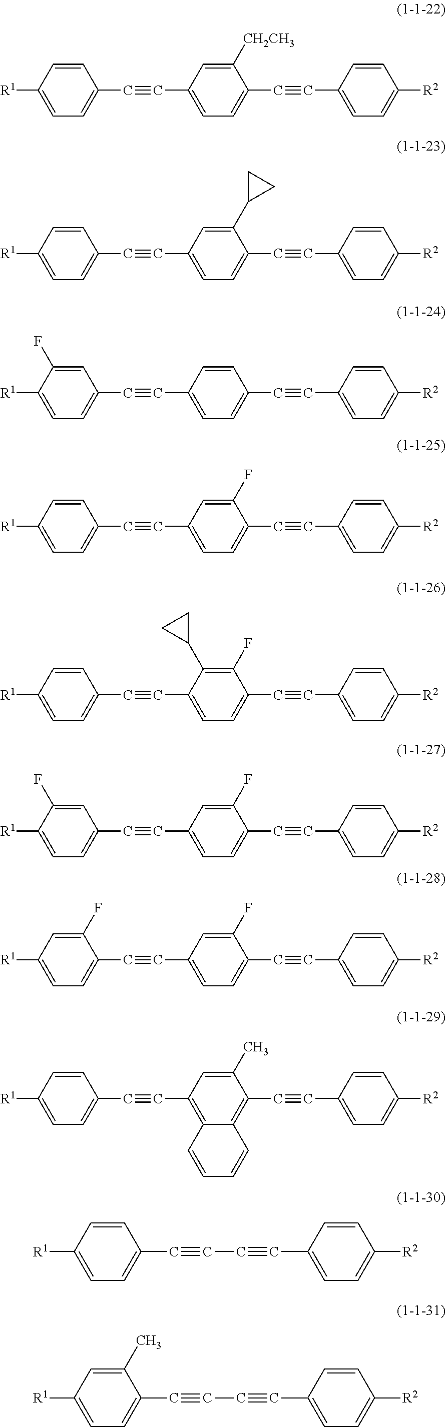

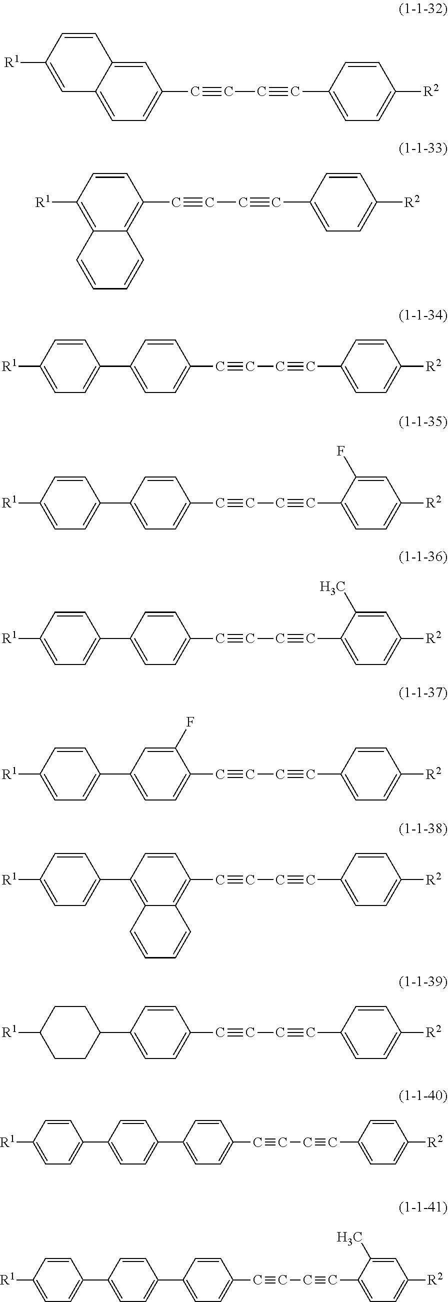

in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R² represents the above R¹, —CN, —F, —Cl, —CF₃, —OCF₃, —CF₂H, —OCF₂H, —NCS, or —SF₅.

[10] The element according to [7], wherein the compound represented by Formula (1-2) is one represented by the following Formula (1-2-1) to Formula (1-2-24):

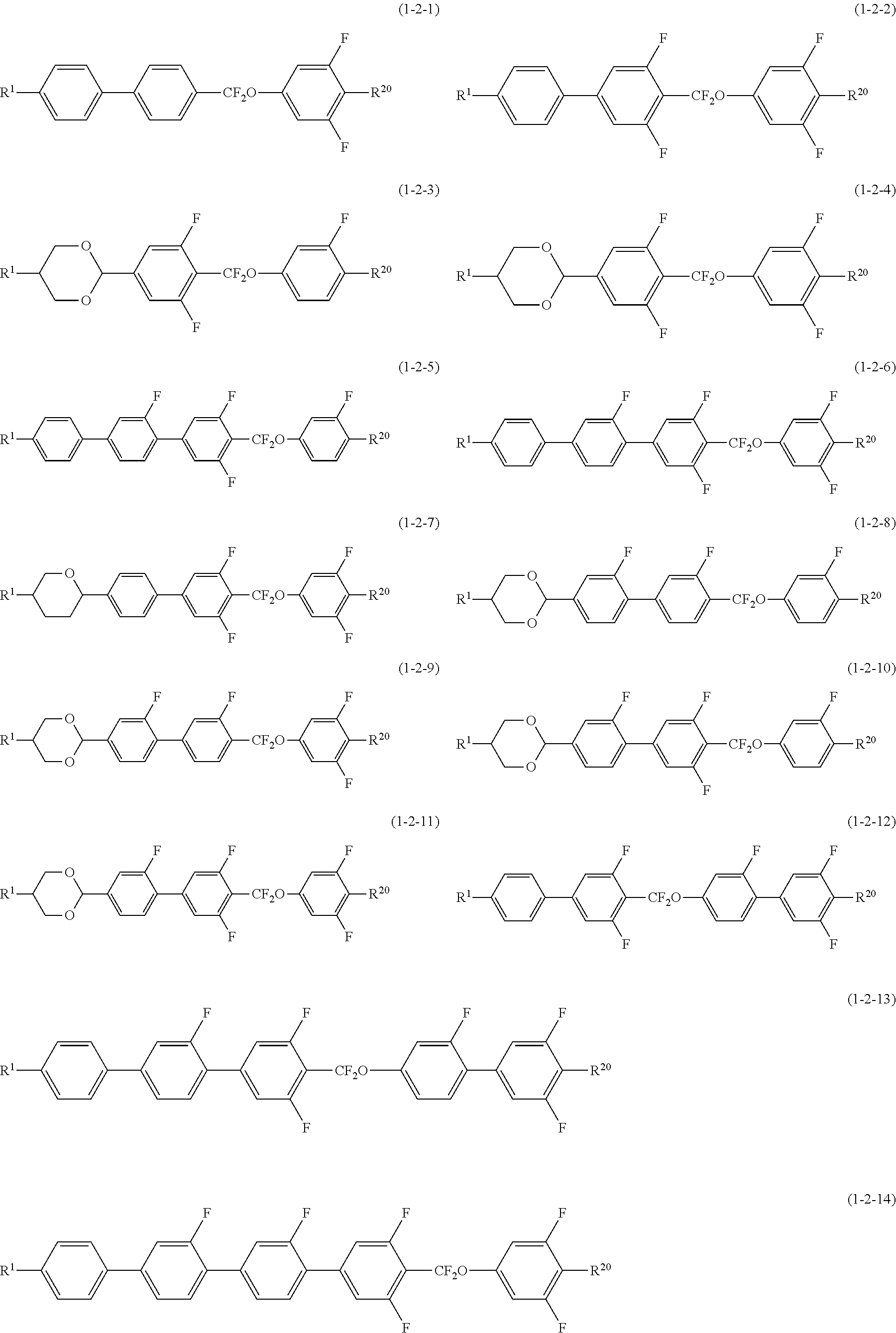

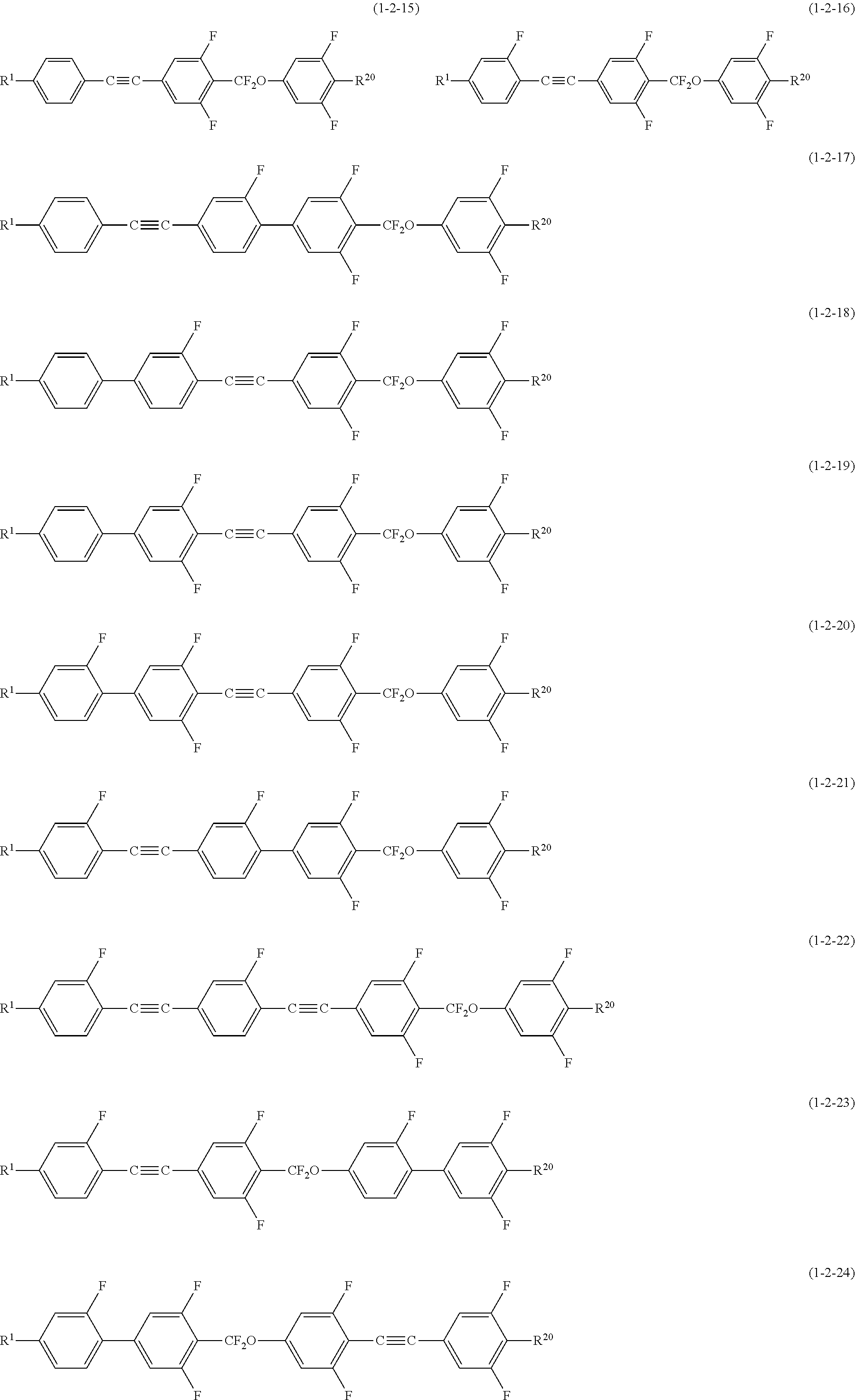

in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R²⁰ is —CN, —F, —Cl, —CF₃, —OCF₃, —CF₂H, —OCF₂H, —NCS, or —SF₅.

[11] The element according to [8], wherein the compound represented by Formula (1-3) is one represented by the following Formula (1-3-1) to Formula (1-3-42):

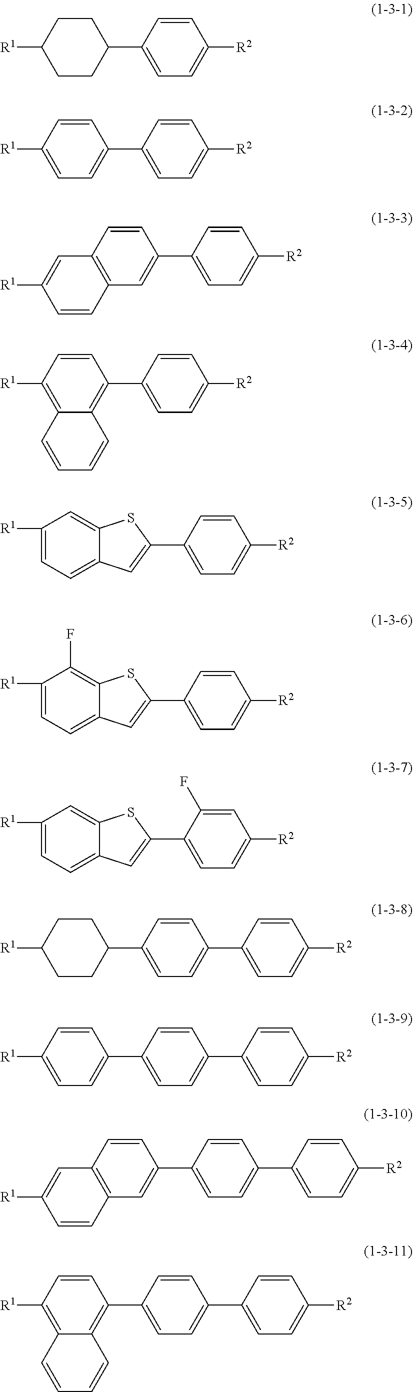

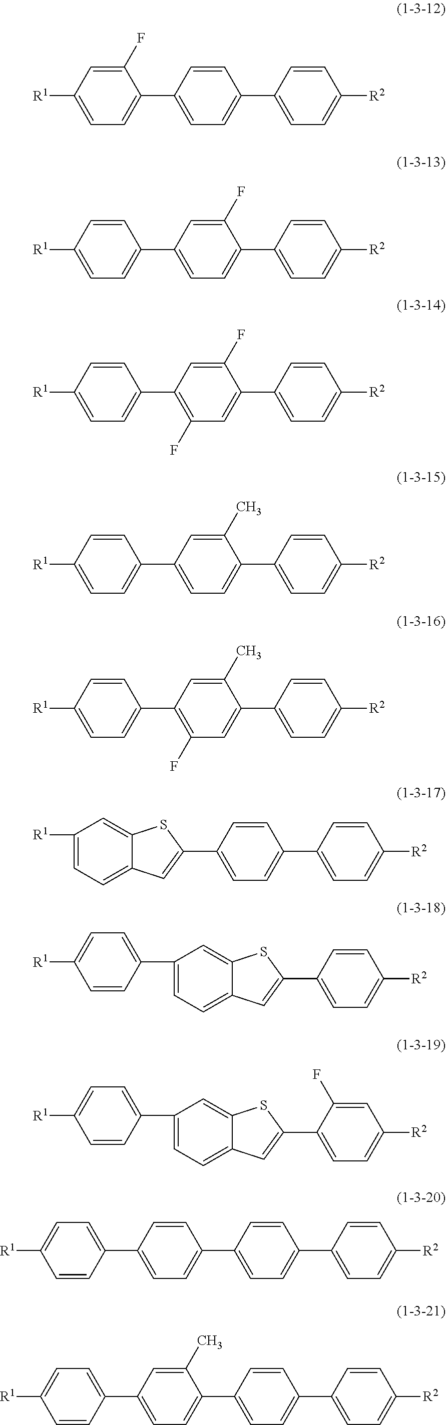

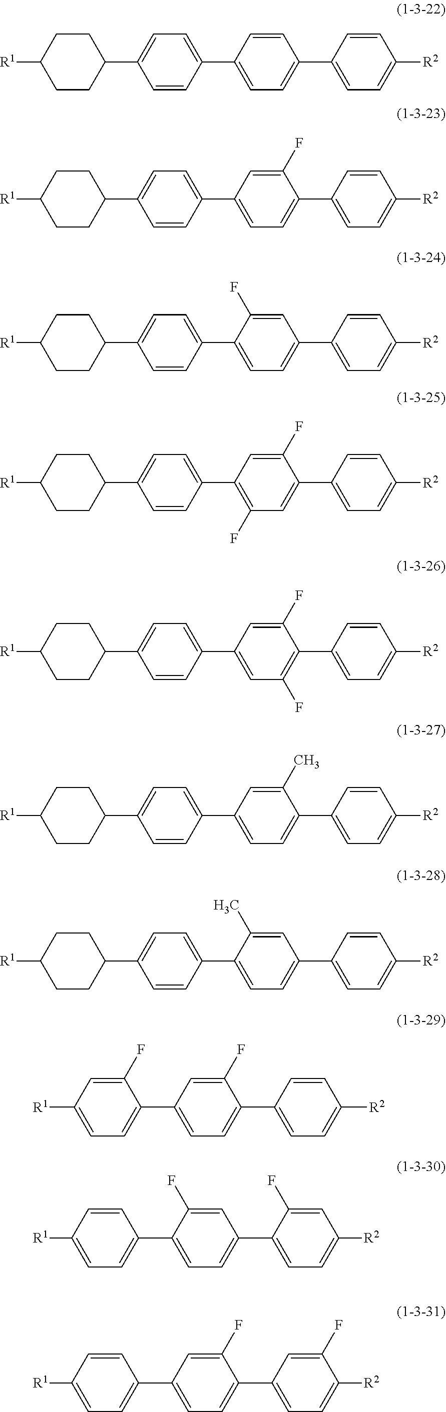

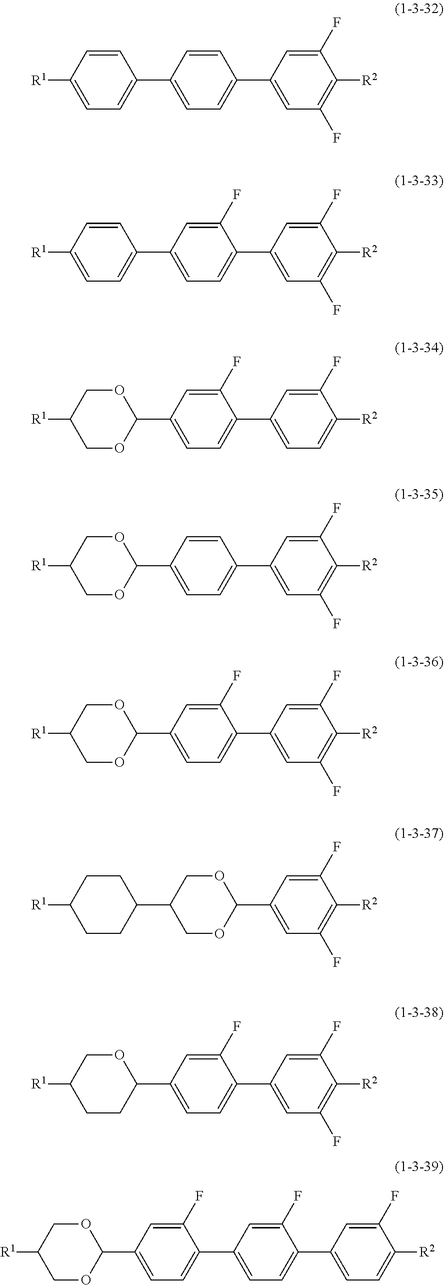

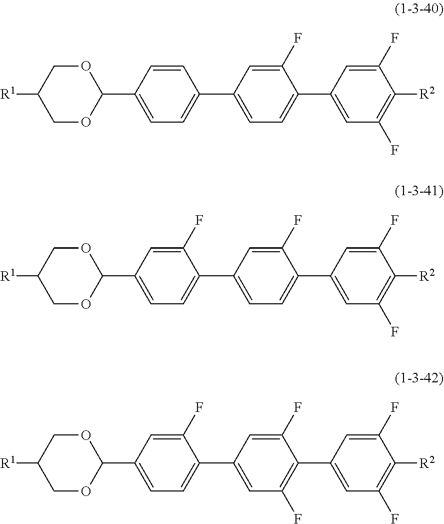

in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R² represents the above R¹, —CN, —F, —Cl, —CF₃, —OCF₃, —CF₂H, —OCF₂H, —NCS, or —SF₅.

[12] The element according to any one of [6] to [11], wherein the liquid crystal composition is a composition including a proportion of 20 weight % to 80 weight % of the compound represented by Formula (1-1) and a proportion of 20 weight % to 80 weight % of the compound represented by Formula (1-2) or the compound represented by Formula (1-3) with respect to the total weight of the liquid crystal composition.

[13] The element according to [1], wherein the liquid crystal composition is a composition including a proportion of 10 weight % or more of the compound in which R² is —CN or —NCS in the compound of Formula (1) with respect to the total weight of the liquid crystal composition.

[14] The element according to any one of [1] to [13], wherein the liquid crystal composition further contains a dichroic dye.

[15] The element according to any one of [1] to [14], wherein the polyimide alignment film is a polyimide film formed by firing an alignment agent containing polyamic acid.

[16] The element according to any one of [1] to [14], wherein the polyimide alignment film is a polyimide film formed by firing an alignment agent composed of a mixture of polyamic acid and a soluble polyimide or polyamic acid ester.

[17] The element according to [15] or [16], wherein the polyimide alignment film is a polyimide film formed by firing an alignment agent additionally containing a silane coupling agent.

[18] The element according to any one of [15] to [17], wherein the polyimide alignment film is a polyimide film formed by firing an alignment agent additionally containing an epoxy compound.

[19] The element according to any one of [15] to [18], wherein the polyimide alignment film is a polyimide film formed by firing an alignment agent additionally containing an anti-rust agent.

[20] The element according to any one of [15] to [19], wherein the polyimide alignment film is rubbed.

[21] The element according to any one of [15] to [19], wherein the polyimide alignment film is subjected to an optical alignment treatment.

[22] The element according to any one of [15] to [21], wherein the polyimide alignment film is formed on copper or aluminum.

The liquid crystal element of the disclosure has large dielectric anisotropy and low dielectric loss in a high frequency range and has a high voltage holding ratio (VHR) when a voltage is applied. Therefore, the element of the disclosure has excellent characteristics for applications, for example, a so-called active drive millimeter-wave band variable phase shifter using a thin film transistor (TFT).

### DESCRIPTION OF THE EMBODIMENTS

Examples of an element used for phase control of an electromagnetic wave signal with a frequency of 1 MHz to 400 THz include a millimeter wave band variable phase shifter and a light detection and ranging (LiDAR) element.

The liquid crystal composition of the disclosure may be simply called a “composition.” In the element of the disclosure, the phase in the “composition” may include not only a nematic phase but also other liquid crystal phases and an isotropic liquid. When used as an element, the phase may be a liquid crystal phase, and a nematic phase is preferable.

“Liquid crystalline compound” refers to a compound having a liquid crystal phase such as a nematic phase and a smectic phase, or a compound that has no liquid crystal phase but is beneficial as a component of a composition. This beneficial compound contains a 6-membered ring such as 1,4-cyclohexylene and 1,4-phenylene and has a linear molecular structure. An optically active compound may be added to a composition. Even if this compound is a liquid crystalline compound, it is classified as an additive here.

An upper limit temperature of a nematic phase may be simply called an “upper limit temperature.” A lower limit temperature of a nematic phase may be simply called a “lower limit temperature.”

The expression “a specific resistance is high” means that a composition has a high specific resistance not only at room temperature in an initial stage but also at a high temperature, and after it is used for a long time, it has a high specific resistance not only at room temperature but also at a high temperature. Values measured in methods described in examples are used to explain characteristics such as optical anisotropy. “Proportion of a compound” refers to a weight percentage (weight %) based on the total weight of the liquid crystalline compound. A proportion of an additive mixed into the composition is a weight percentage (weight %) based on the total weight of the liquid crystalline compound.

The liquid crystal element of the disclosure is characterized by a combination of a liquid crystal composition and a polyimide alignment film. In phase control of an electromagnetic wave signal with a frequency of 1 MHz to 400 THz, a liquid crystal composition having large dielectric anisotropy is preferably used. The dielectric anisotropy with respect to microwaves has a positive correlation with the refractive index anisotropy with respect to visible light. Specifically, the refractive index anisotropy at 589 nm is preferably 0.3 or more. On the other hand, a liquid crystal composition having such characteristics, particularly a liquid crystal composition containing a compound having a —CN or —NCS group, has a strong interaction with a polyimide alignment film and has a low VHR. A liquid crystal element composed of such a composition has poor reliability.

In order to improve the reliability of the above liquid crystal element, it is important to control alignment of liquid crystals in the vicinity of the alignment film. That is, it is necessary to weaken the interaction between the liquid crystal and the alignment film and prevent the occurrence of an electric double layer induced at the alignment film interface. Therefore, it is preferable to introduce an alicyclic structure into the repeating unit of the alignment film.

First, a liquid crystal composition used in the element of the disclosure will be described. The liquid crystal composition contains a compound having a structure represented by Formula (1). In this case, in order to increase the refractive index anisotropy, a compound represented by Formula (1-1) is preferably selected as a component of the composition. In addition, in order to extend an operation temperature range of the element, a group represented by Formula (I), Formula (II), Formula (V), Formula (IX), Formula (X), Formula (XI), or Formula (XXV) is preferably selected as the rings A¹⁰ and A²⁰ in Formula (1-1). In order to improve a response speed of the element, a group represented by Formula (I), Formula (II), Formula (XXV), Formula (XXXIV), Formula (XXXV), or Formula (XXXVI) is most preferably selected as the rings A¹⁰ and A²⁰. On the other hand, in order to reduce loss of the element, a group represented by Formula (I) or Formula (V) substituted with an alkyl group having 1 to 5 carbon atoms is preferably selected as the rings A¹⁰ and A²⁰.

In order to lower the viscosity while maintaining the refractive index anisotropy of the composition, it is most preferable to select a single bond as Z¹ in Formula (1-1). In addition, in order to further increase the refractive index anisotropy of the composition, it is most preferable to select —C≡C— as Z¹.

In order to increase the refractive index anisotropy of the composition, it is more preferable to select an alkyl group in which —CH₂— adjacent to A¹ is substituted with —O— or —S— for R¹ in Formula (1-1). On the other hand, in order to improve a response speed of the element, it is more preferable to select an unsubstituted alkyl group for R¹.

In order to increase the refractive index anisotropy of the composition, it is preferable to select an unsubstituted alkyl group, an alkyl group in which —CH₂— adjacent to A¹ is substituted with —O— or —S—, —CN, or —NCS for R² in Formula (1-1).

Compounds most suitable for increasing the refractive index anisotropy of the composition are compounds of Formula (1-1-1) to Formula (1-1-41).

In applications to, for example, millimeter wave antennas and LiDAR for a moving object used for automatic driving or the like, a response speed is particularly required as a characteristic of the liquid crystal element. In order to improve a response speed of the element, it is necessary to minimize the viscosity of the liquid crystal composition. In addition, in order to reduce power consumption of the element, low voltage driving is required. For such required characteristics, it is preferable to select a compound represented by Formula (1-2) having a low viscosity and a large dielectric anisotropy as a component of the composition. In this case, in order to further low voltage driving the element, it is preferable to select —CN, —F, —CF₃, —OCF₃, —CF₂H, —OCF₂H, —NCS, or —SF₅ and it is most preferable to select —CN, —F, —CF₃, —OCF₃, or —NCS for R² in Formula (1-2).

In the compound represented by Formula (1-2), in order to further lower the viscosity of the composition, it is most preferable to select a single bond as Z¹¹. In addition, in order to increase the refractive index anisotropy of the composition, it is most preferable to select —C≡C—.

In order to extend an operation temperature range of the element, a group represented by Formula (I), Formula (II), Formula (X), Formula (XXXIV), Formula (XXXV), or Formula (XXXVI) is preferably selected as the rings A¹⁰, A²⁰, and A³¹ in Formula (1-2). In order to improve a response speed of the element, it is most preferable to select a group represented by Formula (I), Formula (II), Formula (XXXIV), Formula (XXXV), or Formula (XXXVI) as the rings A¹⁰, A²⁰, and A³¹. On the other hand, in order to reduce loss of the element, it is preferable to select a group represented by Formula (I) or Formula (V) substituted with an alkyl group having 1 to 5 carbon atoms as the rings A¹⁰, A²⁰, and A³¹.

In order to improve a response speed of the element, it is more preferable to select an unsubstituted alkyl group for R¹ in Formula (1-2). In addition, in order to increase the refractive index anisotropy of the composition, it is more preferable to select an alkyl group in which —CH₂— adjacent to A¹ is substituted with —O— or —S— for R¹.

Compounds most suitable for reducing the viscosity of the composition and increasing the dielectric anisotropy are compounds of Formula (1-2-1) to Formula (1-2-12). Compounds most suitable for increasing the dielectric anisotropy and refractive index anisotropy of the composition are compounds of Formula (1-2-13) to Formula (1-2-24).

In applications such as automatic driving, a wide operation temperature range is particularly required as a characteristic of the liquid crystal element. In order to extend an operation temperature range of the element, a composition having a wide nematic liquid crystal temperature range and high compatibility is required. In order to prepare such a composition, it is preferable to select a compound represented by Formula (1-3).

In order to improve the compatibility of the composition, for the rings A¹⁰ and A²⁰ of the compound represented by Formula (1-3) it is preferable to select a compound which is a group represented by Formula (I), Formula (XXXIV), Formula (XXXV), or Formula (XXXVI) and in which m1=0. In addition, in order to improve the compatibility while maintaining the refractive index anisotropy of the composition, for the rings A¹⁰ and A²⁰, it is preferable to select a compound which is represented by Formula (I), Formula (II), or Formula (XXV) and in which m1=0. In order to extend a nematic liquid crystal temperature range of the composition, for the rings A¹⁰ and A²⁰, it is preferable to select a compound which is represented by Formula (I), Formula (XXXIV), Formula (XXXV), or Formula (XXXVI) and in which m1=1 or 2. In addition, in order to extend a nematic liquid crystal temperature range while maintaining the refractive index anisotropy of the composition, for the rings A¹⁰ and A²⁰, it is preferable to select a compound which is a group represented by Formula (I), Formula (II), or Formula (XXV) and in which m1=1 or 2.

In order to reduce loss of the element, it is preferable to select a group represented by Formula (I) or Formula (V) substituted with an alkyl group having 1 to 5 carbon atoms for A¹⁰ and A²⁰ of the compound represented by Formula (1-3).

In order to improve the compatibility of the composition, it is more preferable to select an unsubstituted alkyl group for R¹ and R² of the compound represented by Formula (1-3). In addition, at the same time, in order to improve the dielectric anisotropy, it is preferable to select —F, —CF₃, —OCF₃, —CF₂H, or —OCF₂H for R². In addition, in order to improve the refractive index anisotropy while maintaining the compatibility of the composition, more preferably, an alkyl group in which —CH₂— adjacent to A¹⁰ is substituted with —O— or —S— is selected for R¹, and an alkyl group in which —CH₂— adjacent to phenylene is substituted with —O— or —S—, —CN, or —NCS is selected for R².

Compounds most suitable for extending an operation temperature range of the element are compounds of Formula (1-3-1) to Formula (1-3-28). Compounds most suitable for lowering a driving voltage of the element and extending an operation temperature range are compounds of Formula (1-3-29) to Formula (1-3-42).

R¹ and R² of the compound of Formula (1) will be described in detail. In order to extend a nematic phase temperature range of the composition, preferable alkyl groups include methyl, ethyl, propyl, butyl, pentyl, hexyl, heptyl, and octyl groups. More preferable alkyl groups include ethyl, propyl, butyl, pentyl, and heptyl groups in order to lower the viscosity.

For R¹ and R² of the compound of Formula (1), in order to extend a nematic phase temperature range of the composition, preferable alkoxy groups include methoxy, ethoxy, propoxy, butoxy, pentyloxy, hexyloxy, and heptyloxy groups. More preferable alkoxy groups include methoxy and ethoxy groups in order to lower the viscosity.

For R¹ and R² of the compound of Formula (1), in order to extend a nematic phase temperature range of the composition, preferable alkenyl groups include vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, and 5-hexenyl groups. More preferable alkenyl groups include vinyl, 1-propenyl, 3-butenyl, and 3-pentenyl groups in order to lower the viscosity. A preferable configuration of —CH═CH— in these alkenyl groups depends on the position of a double bond. In order to lower the viscosity, trans is preferable in the alkenyl groups such as 1-propenyl, 1-butenyl, 1-pentenyl, 1-hexenyl, 3-pentenyl, and 3-hexenyl groups. Cis is preferable in the alkenyl group such as 2-butenyl, 2-pentenyl, and 2-hexenyl groups. In these alkenyl groups, a linear alkenyl is preferable to a branched alkenyl group.

In order to improve the dielectric anisotropy while maintaining the refractive index anisotropy of the composition, it is more preferable to select —CN or —NCS for R². In addition, in order to improve the dielectric anisotropy while maintaining the viscosity of the composition, for R², it is preferable to select —F, —CF₃, —OCF₃, —CF₂H, —OCF₂H, or —SF₅ and it is more preferable to select —F, —CF₃, or —OCF₃.

In order to satisfy characteristics such as dielectric anisotropy in a high frequency range, dielectric loss in a high frequency range, a driving voltage, and an operation temperature range at a high level required for the element, the composition is preferably a mixture of compounds of Formula (1-1) and Formula (1-2) or Formula (1-3). In this case, the content of the compound of Formula (1-1) with respect to the composition is preferably 20 weight % to 80 weight % with respect to the total weight of the liquid crystal composition. The content is more preferably 10 weight % to 70 weight %. In addition, the content of the compound of Formula (1-2) or Formula (1-3) with respect to the composition is preferably 20 weight % to 80 weight % or more preferably 30 weight % to 80 weight %.

In order to reduce deterioration of the above liquid crystal composition due to heat and light, a light stabilizer, an antioxidant, and the like may be added to the composition of the disclosure. Regarding such a light stabilizer and antioxidant, compounds represented by the following Formula (AI) are suitable because their effects are strong and they can prevent a liquid phase temperature range of the composition from being narrowed.

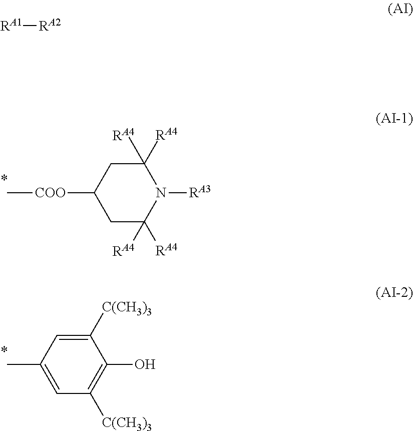

Here, R¹ is a group of Formula (AI-1) or Formula (AI-2), and in Formula (AI-1) or Formula (AI-2), R^{A3} represents a hydrogen atom or an alkyl group having 1 to 5 carbon atoms, R^{A4}'s are independently an alkyl group having 1 to 5 carbon atoms, and * indicates a bonding position. R^{A2} represents an organic group having 1 to 18 carbon atoms, and one to three of —H of the organic group may be replaced with a structure of Formula (AI-1) or Formula (AI-2) like R^{A1}.

In Compound (AI), a compound having a structure of (AI-1) is a light stabilizer, and a compound having a structure of (AI-2) is an antioxidant. Regarding the antioxidant, it is preferable to select a compound of the following Formula (AI-2-1). In Formula (AI-2-1), k represents an integer of 1 to 12.

In particular, since Compound (AI-2-1) in which k is 1 has high volatility, it is effective to prevent reduction in a specific resistance due to heat in the air. Since Compound (AI-2-1) in which k is 7 has low volatility, it is effective to maintain the reliability not only at room temperature but also at a relatively high temperature after a high frequency antenna is used for a long time.

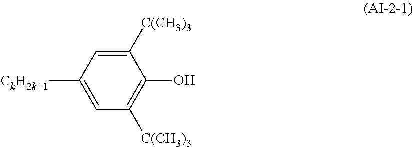

A preferable proportion of the light stabilizer is 100 ppm or more in order to obtain effects thereof and is 0.5% or less in order to prevent the upper limit temperature from decreasing or prevent the lower limit temperature from increasing. A more preferable proportion is 100 ppm to 1,000 ppm. In addition, a preferable proportion of the antioxidant is 50 ppm or more in order to obtain effects thereof, and is 600 ppm or less in order to prevent the upper limit temperature from decreasing or prevent the lower limit temperature from increasing. A more preferable proportion is 100 ppm to 300 ppm.

An optically active compound may be added to the composition of the disclosure. The compound is mixed into the composition in order to form a twist angle by inducing a liquid crystal helical structure. Examples of such a compound include Compounds (C-1) to (C-5). A preferable proportion of the optically active compound is 5% or less. A more preferable proportion is in a range of 0.01% to 2%.

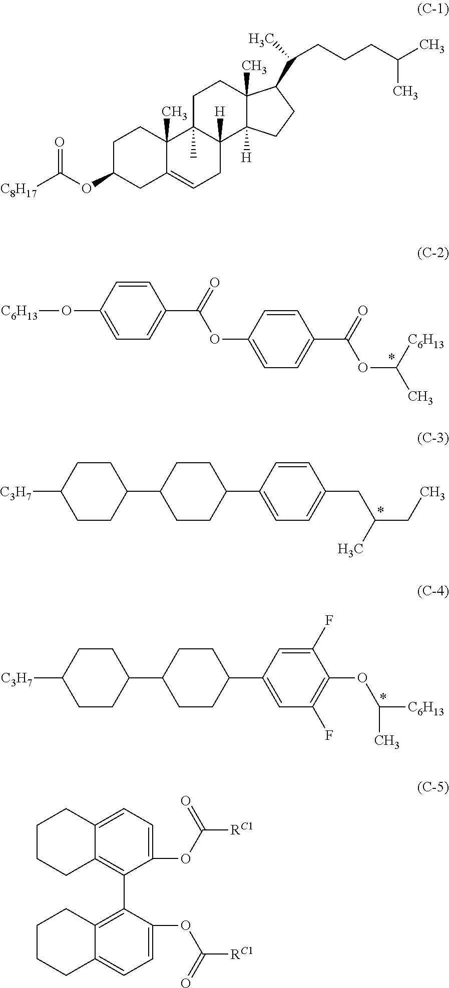

In Formula (C-5), R^{C1}'s independently represent a hydrocarbon having a ring structure and up to 30 carbon atoms. * indicates an asymmetric carbon atom.

In order to improve the anisotropy at a frequency of 1 MHz to 400 THz, azo, carotenoid, flavonoid, quinone and porphyrin dyes may be contained in the composition of the disclosure.

A polymerizable compound may be contained in the composition of the disclosure in order to improve characteristics. For such purposes, examples in which characteristics of an antenna element are improved using a polymer-dispersed type liquid crystal include IEEJ Transactions on Fundamentals and Materials, vol. 137, No. 6, pp. 356 (2017). Also in the composition of the disclosure, for the purpose of such improvement, a polymerizable compound may be added to the composition. Regarding such a polymerizable compound, in order to maintain electrical characteristics of the element, a radically polymerizable compound is preferable, and in consideration of the reactivity during polymerization and the solubility in a liquid crystal, a (meth)acrylic group is more preferably selected.

Regarding those suitably used as such a polymerizable compound, first, (meth)acrylic derivatives having a framework similar to that of a liquid crystal may be exemplified. These compounds are suitably used when the composition that is aligned in one direction is used because they do not significantly reduce a phase transition point of the composition. Regarding those suitable as such compounds, compounds represented by the following Formula (M-1) to Formula (M-3) may be exemplified.

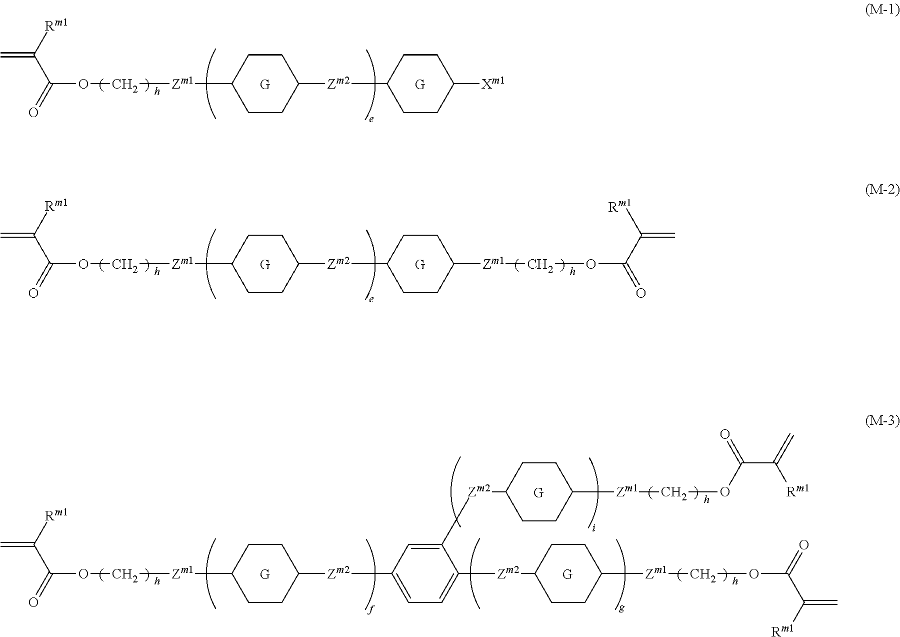

In Formula (M-1), Formula (M-2), and Formula (M-3), the rings G independently represent 1,4-cyclohexylene, 1,4-phenylene, 1,3-dioxane-2,5-diyl, naphthalene-2,6-diyl, or fluorene-2,7-diyl, and here, at least one hydrogen atom in the ring G may be substituted with a fluorine atom, a trifluoromethyl group, an alkyl group having 1 to 12 carbon atoms, an alkoxy group having 1 to 12 carbon atoms, an alkoxycarbonyl group having 1 to 12 carbon atoms, or an alkanoyl group having 1 to 12 carbon atoms; Z^{m1}'s independently represent a single bond, —OCH₂—, —COO—, or —OCOO—; Z^{m2} represents a single bond, —O—, —OCH₂—, or —COO—; X^{m1} represents a hydrogen atom, a fluorine atom, a chlorine atom, a trifluoromethyl group, a trifluoromethoxy group, a cyano group, an alkyl group having 1 to 20 carbon atoms, an alkenyl group having 2 to 20 carbon atoms, an alkoxy group having 1 to 20 carbon atoms, or an alkoxy carbonyl group having 1 to 20 carbon atoms; e represents an integer of 1 to 4; f and g are independently an integer of 0 to 3; a sum of f and g is 1 to 4; i is 0 or 1, h's are independently an integer of 0 to 20; and R^{m1}'s independently represent a hydrogen atom or CH₃.

Regarding those suitably used as such a polymerizable compound, additionally, (meth)acrylic derivatives having no framework similar to that of a liquid crystal may be exemplified. These compounds are suitably used when a driving voltage of the element is lowered. Regarding those suitable as such compounds, a compound represented by the following Formula (M-4) may be exemplified.

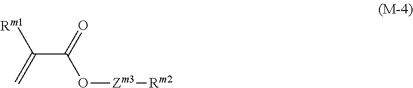

In Formula (M-4), Z^{m3} represents a single bond or an alkylene group having 1 to 80 carbon atoms, and at least one hydrogen atom in Z^{m3} may be substituted with an alkyl group having 1 to 20 carbon atoms, a fluorine atom, or a group of the following Formula (7), and at least one —CH₂— may be substituted with —O—, —CO—, —COO—, —OCO—, —NH—, or —N(R^{m3})—; when substituted with a plurality of —O-'s, these —O-'s are not adjacent, R^{m3} represents an alkyl group having 1 to 12 carbon atoms, and at least one —CH₂—CH₂— may be substituted with —CH═CH— or —C≡C—;

R^{m2} represents an alkyl group having 1 to 20 carbon atoms, at least one hydrogen atom in R^{m2} may be substituted with a fluorine atom, at least one —CH₂— may be substituted with —O—, —CO—, —COO—, or —OCO—, and when substituted with a plurality of —O-'s, these —O-'s are not adjacent, at least one —CH₂— may be substituted with a divalent group generated by removing two hydrogen atoms from a carbocyclic saturated aliphatic compound, a heterocyclic saturated aliphatic compound, a carbocyclic unsaturated aliphatic compound, or a heterocyclic unsaturated aliphatic compound, and these divalent groups have 5 to 35 carbon atoms, and in these divalent groups, at least one hydrogen atom may be substituted with an alkyl group having 1 to 12 carbon atoms, and in the alkyl group as a substituent, one —CH₂— may be substituted with —O—, —CO—, —COO—, or —OCO—; R^{m1} represents a hydrogen atom or CH₃.

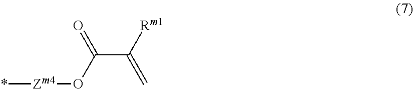

In Formula (7), Z^{m4} represents an alkylene group having 1 to 12 carbon atoms, R^{m1} represents a hydrogen atom or CH₃, and * indicates a bonding position.

Suitable examples of the compounds represented by Formula (M-1) to Formula (M-4) include the following formulae.

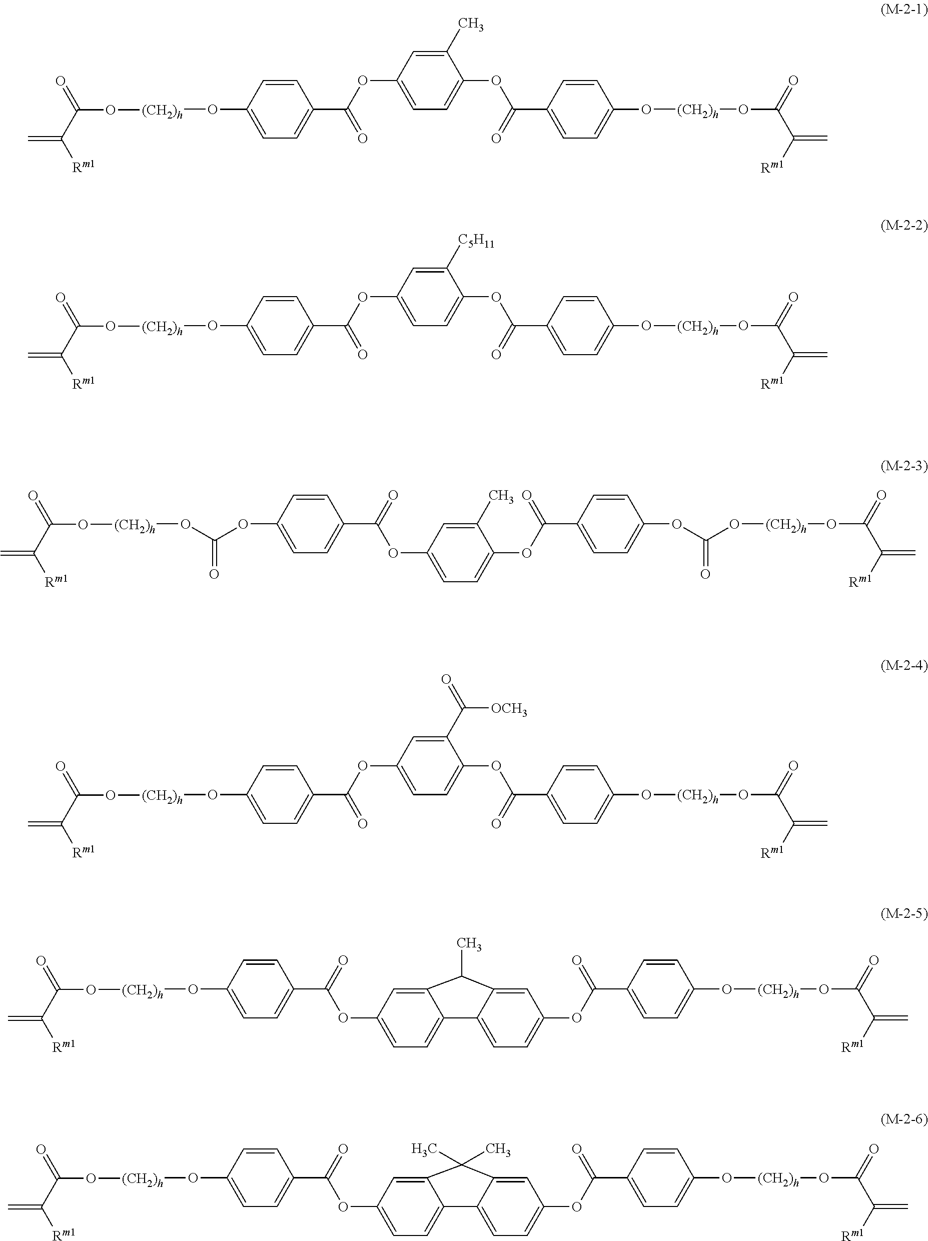

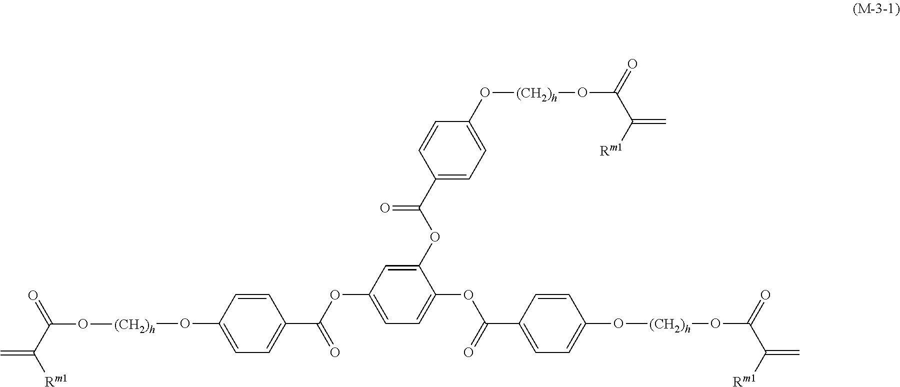

In the above formulae, R^{m1} 's independently represent a hydrogen atom or CH₃, and h's independently represent an integer of 1 to 20.

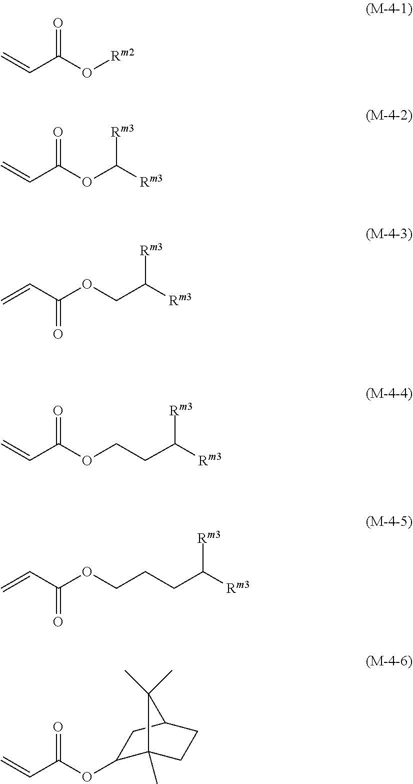

In Formula (M-4-1) to (M-4-6), R^{m2} represents a linear alkyl group having 1 to 20 carbon atoms, at least one —CH₂— in R^{m2} may be substituted with —O—, —CO—, —COO—, or —OCO—, R^{m3}'s independently represent an alkyl group having 3 to 10 carbon atoms, and in the alkyl group, at least one —CH₂— may be substituted with —O—, —CO—, —COO—, or —OCO—.

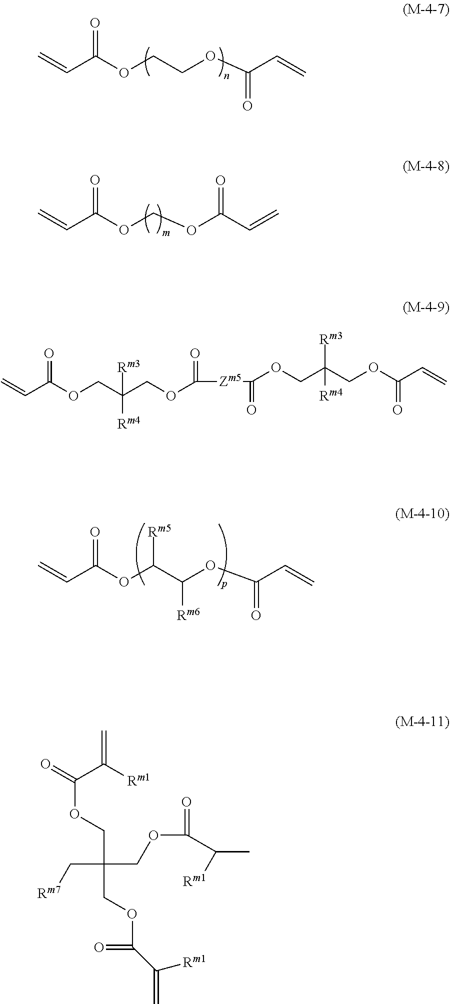

In Formula (M-4-7), n represents an integer of 1 to 10, and in Formula (M-4-8), m represents an integer of 2 to 20,

in Formula (M-4-9), R^{m3}'s independently represent an alkyl group having 1 to 5 carbon atoms, R^{m4}'s independently represent an alkyl group having 1 to 20 carbon atoms, and in the alkyl group, at least one —CH₂— may be substituted with —O—, —CO—, —COO—, or —OCO—, and R^{m3} and R^{m4} in the same formula may be the same as or different from each other,

Z^{m5} represents an alkylene group having 10 to 30 carbon atoms, and in the alkylene group, at least one —CH₂— may be substituted with —O—, —CO—, —COO—, or —OCO—, and the alkylene group include those having a branched alkyl group,

in Formula (M-4-10), p represents an integer of 3 to 10, and R^{m5} and R^{m6} area hydrogen atom or CH₃, and any one of them is CH₃,

in Formula (M-4-11), R^{m7} has a structure in which OH, a (meth)acryloyl group, or the residues other than R^{m7} in Formula (M-4-11) are bonded via —O—, and R^{m1}'s each independently represent a hydrogen atom or CH₃. Formula (M-4-11-1), a compound in which R^{m7} has a structure in which the residues other than R^{m7} in Formula (M-4-11) are bonded via —O—, is shown below.

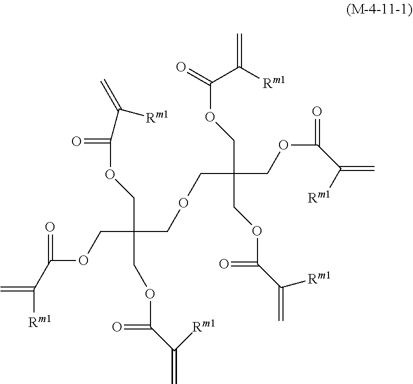

Second, a polyimide alignment film will be described. In order to obtain desired characteristics in the element of the disclosure, the proportion of the repeating unit of Formula (2) in the polyimide alignment film with respect to all repeating units is preferably 0.1 to 1, more preferably 0.2 to 1, and most preferably 0.3 to 1. The proportion is the same whether the polyimide alignment film is made of one type of polymer or two or more types of polymers blended.

In the element of the disclosure, in order to improve resistance to rubbing, optical alignment properties, and the like, a repeating unit other than Formula (2) may be introduced into the polyimide alignment film. The proportion of the repeating unit other than Formula (2) is preferably 0 to 0.9, more preferably 0 to 0.8, and most preferably 0 to 0.7 with respect to all repeating units. The proportion is the same whether the polyimide alignment film is made of one type of polymer or two or more types of polymers blended.

In the case of an alignment film in which two or more types of polymers are blended, a specific polyimide may be segregated at the liquid crystal interface. In order to obtain an element having characteristics of the disclosure, it is more preferable to introduce a repeating unit represented by Formula (2) into the above segregated polyimide.

The polyimide alignment film used in the element of the disclosure can be obtained as follows. That is, a polyamic acid is obtained by reacting a tetracarboxylic dianhydride represented by the following Formula (AN-1) to Formula (AN-7) with a known diamine compound in a solvent such as N-methyl-2-pyrrolidone (abbreviation NMP). A polyimide alignment film can be obtained by applying this polyamic acid to a substrate on which a metal electrode such as copper or aluminum is arranged and firing it.

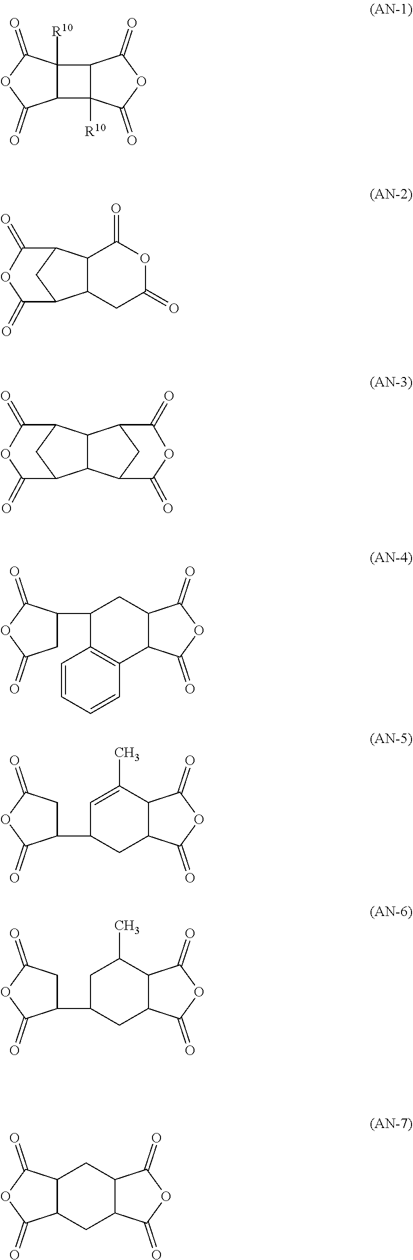

(in the formulae, R¹⁰'s each independently represent a hydrogen atom, CH₃, CH₂CH₃, or a phenyl group.)

In this case, in order to obtain an element having a high voltage holding ratio, which is characterized by the disclosure, acid anhydrides represented by Formula (AN-1) to Formula (AN-3) are preferably used.

In the element of the disclosure, in the polyimide alignment film, in order to improve resistance to rubbing, optical alignment performance, and the like, a tetracarboxylic dianhydride other than Formula (AN-1) to Formula (AN-7) may be used in combination. In this case, examples of preferable tetracarboxylic dianhydrides include the following Formula (AN-8) to Formula (AN-20). In this case, in order to improve resistance to rubbing, compounds of Formula (AN-8) and Formula (AN-11) are preferably selected, and in order to improve optical alignment performance, compounds of Formula (AN-11), Formula (AN-14), Formula (AN-16), and Formula (AN-18) to Formula (AN-20) are preferably selected.

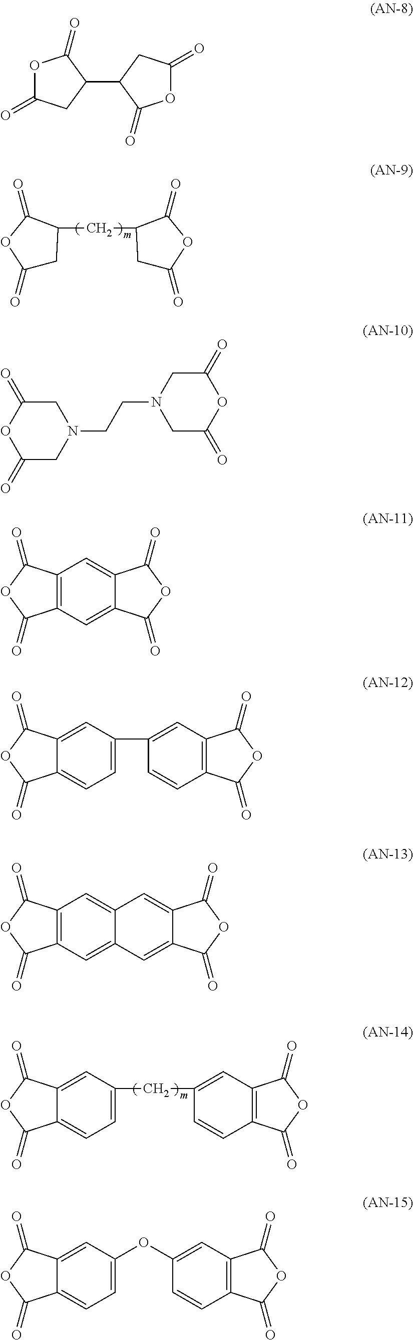

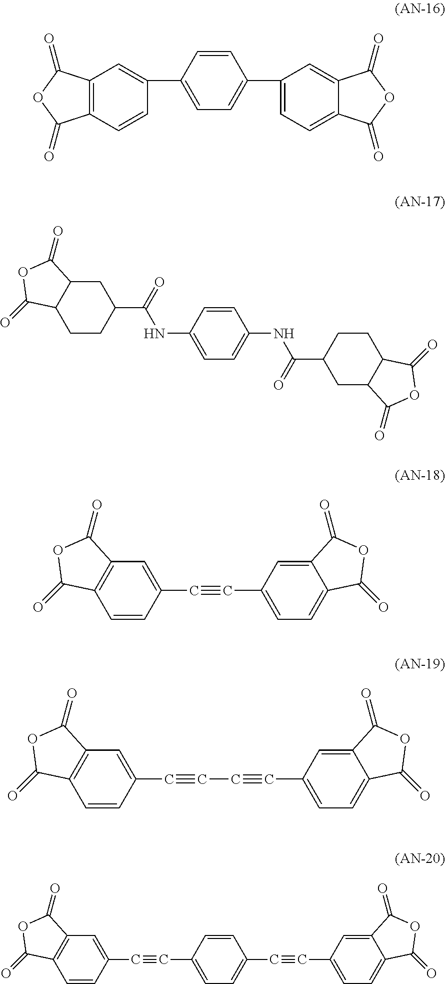 [SMILES: O=C1OC(=O)c2cc(-c3ccc(-c4ccc5c(c4)C(=O)OC5=O)cc3)ccc21 ; O=C(Nc1ccc(NC(=O)C2CCC3C(=O)OC(=O)C3C2)cc1)C1CCC2C(=O)OC(=O)C2C1 ; O=C1OC(=O)c2cc(C#Cc3ccc4c(c3)C(=O)OC4=O)ccc21 ; O=C1OC(=O)c2cc(C#CC#Cc3ccc4c(c3)C(=O)OC4=O)ccc21 ; O=C1OC(=O)c2cc(C#Cc3ccc(C#Cc4ccc5c(c4)C(=O)OC5=O)cc3)ccc21]

(in the formulae, m represents an integer of 1 to 12.)

When tetracarboxylic dianhydrides represented by Formula (AN-1) to Formula (AN-7) are used, a highly reliable element can be obtained regardless of the type of diamine which is the other raw material. However, in order to obtain higher reliability, a diamine represented by the following formula is preferably used.

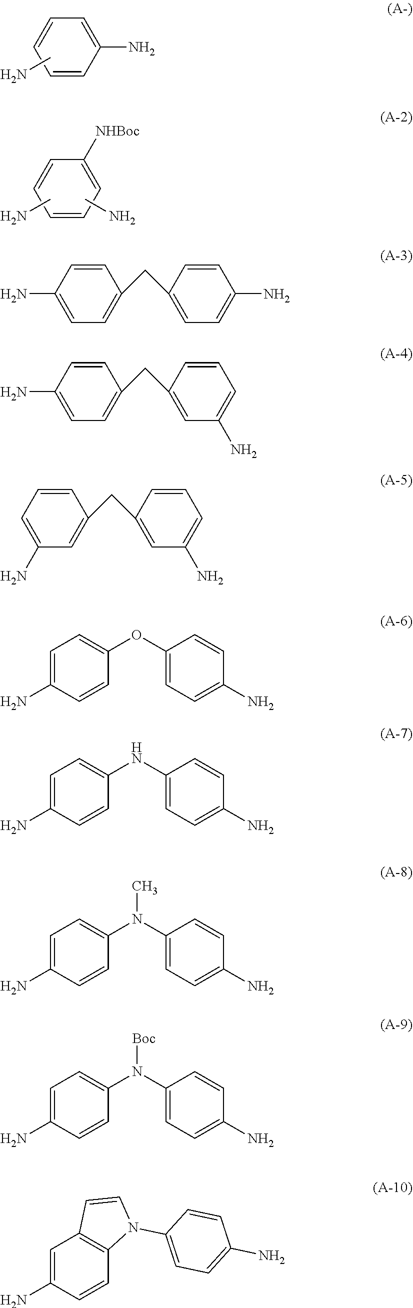

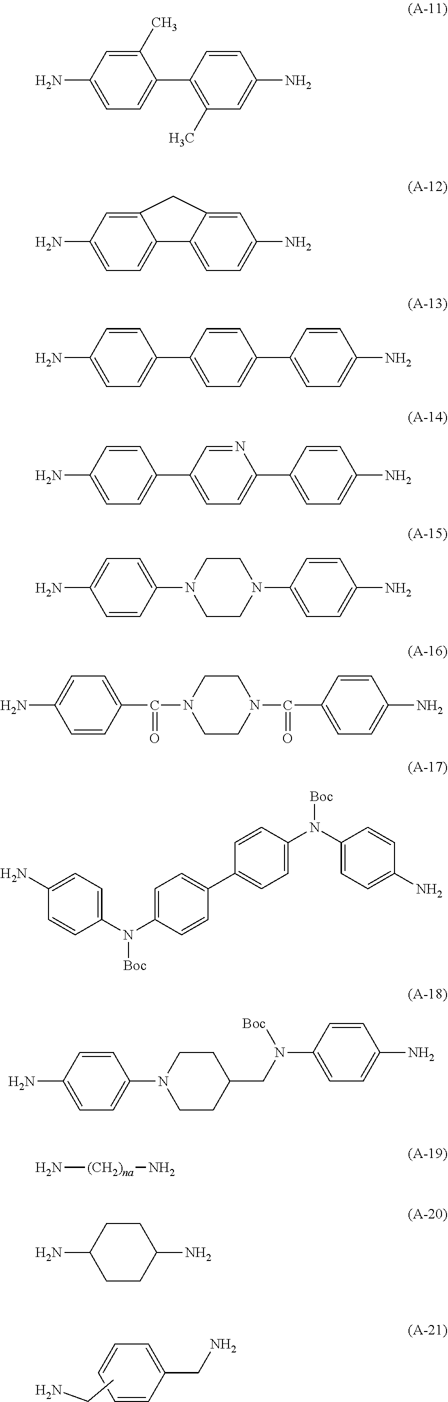

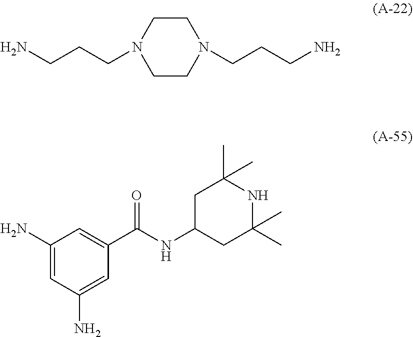 [SMILES: NCCCN1CCN(CCCN)CC1 ; CC1(C)CC(NC(=O)c2cc(N)cc(N)c2)CC(C)(C)N1]

na represents an integer of 1 to 8, and Boc represents t-butoxycarbonyl.

Diamines represented by Formula (A-1) to Formula (A-22), and Formula (A-55) particularly contribute to improving the reliability of the element. In this case, in order to further improve the reliability of the element, it is preferable to select a compound of Formula (A-1) to Formula (A-10), or Formula (A-15), and it is more preferable to select a compound of Formula (A-1), Formula (A-3), Formula (A-6), Formula (A-7), or Formula (A-15).

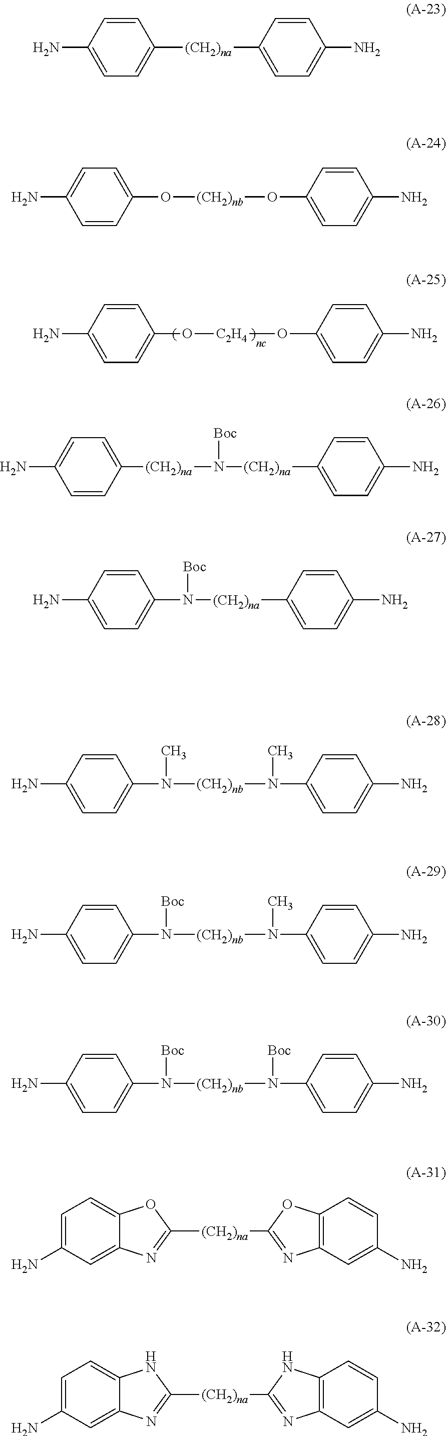

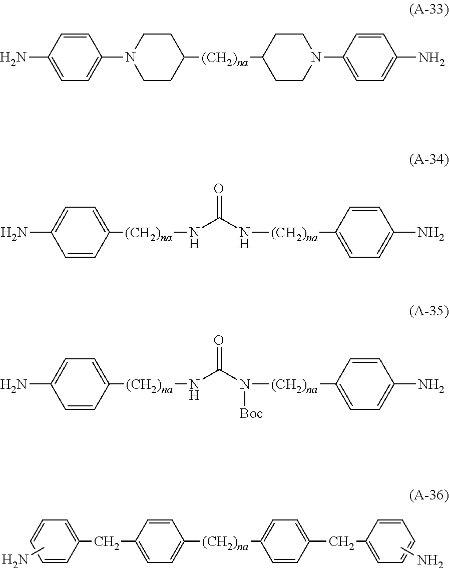

na represents an integer of 1 to 8, nb represents an integer of 2 to 8, nc represents an integer of 2 to 3, and Boc represents t-butoxycarbonyl.

Diamines represented by Formula (A-23) to Formula (A-36) effectively contribute to imparting alignment properties to the alignment film. Therefore, it can be suitably used to improve stability of the element production process. In this case, in order to further improve stability of the element production process, a compound of Formula (A-23), Formula (A-24), Formula (A-26), Formula (A-28), or Formula (A-33) to Formula (A-36) is preferably selected. A compound of Formula (A-23), Formula (A-24), Formula (A-26), or Formula (A-28) or a compound of Formula (A-34) to Formula (A-36) is more preferably selected.

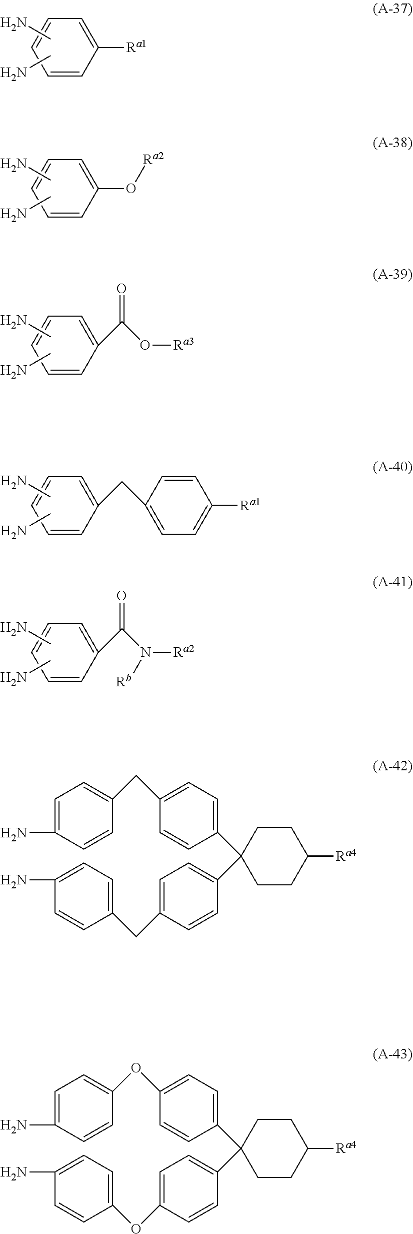

R^{a1} represents an alkyl group having 5 to 12 carbon atoms, R^{a} represents an alkyl group having 5 to 12 carbon atoms, or a phenylene in which the 4-position may be substituted with a hydrocarbon having 1 to 24 carbon atoms, R^{a3} represents an alkyl group having 5 to 12 carbon atoms, or a phenylene or cholesteryl in which the 4-position may be substituted a hydrocarbon having 1 to 24 carbon atoms, R^{a4} represents a hydrogen atom, an alkyl group having 1 to 12 carbon atoms, a phenylene in which the 4-position may be substituted with an alkyl group having 1 to 12 carbon atoms or a cyclohexylene in which the 4-position may be substituted with an alkyl group having 1 to 12 carbon atoms, and Rb represents a hydrogen atom or a methyl group.

Diamines represented by Formula (A-37) to Formula (A-43) contribute to imparting a pretilt (Pt) angle to the liquid crystal of the alignment film while maintaining high reliability. Therefore, it can be suitably used for diversification of driving methods in the liquid crystal element. In this case, in order to impart a higher Pt angle expressing ability, diamines represented by Formula (A-37) to Formula (A-40) are preferably selected, and diamines represented by Formula (A-38) to Formula (A-40) are more preferably selected.

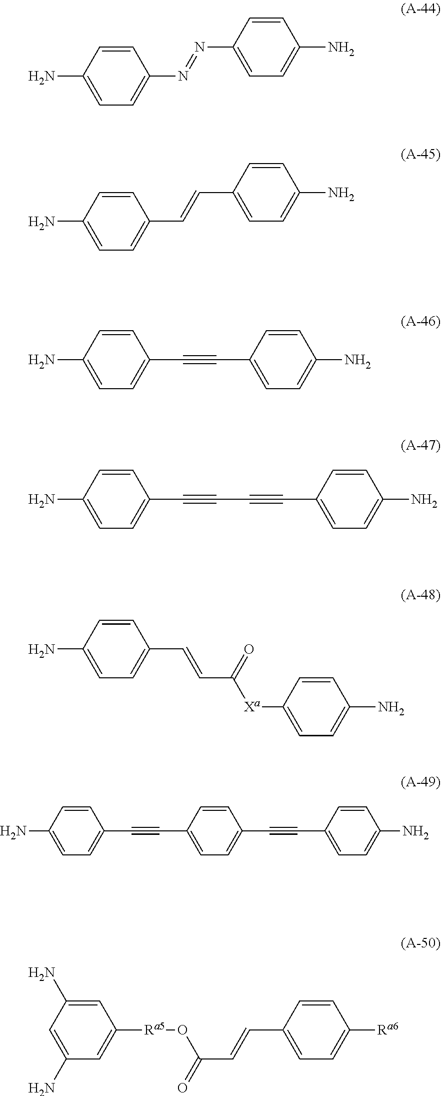

In the formulae, X^{a} represents —O—, —NN—, or —NMe-, R^{a5} represents an alkylene group having 1 to 10 carbon atoms, and in this case, one —CH₂— may be substituted with —O— or —CO₂—, R^{a6} represents an alkylene group having 1 to 10 carbon atoms, and in this case, one —CH₂— may be substituted with —O—, and 1 to 21 —H may be substituted with —F.

Diamines represented by Formula (A-44) to Formula (A-50) are raw materials of a so-called optical alignment film that imparts alignment properties with respect to a liquid crystal to the alignment film with light. When an optical alignment film is used in the element of the disclosure, it is possible to reduce an area in which rubbing cannot be performed due to steps and the like, and prevent poor alignment due to the alignment film being scraped off. Diamines represented by Formula (A-44) to Formula (A-50) are suitably used in order to impart high liquid crystal alignment performance to the alignment film. In this case, in order to impart higher liquid crystal alignment performance, it is most suitable to select diamines represented by Formula (A-44) and Formula (A-50).

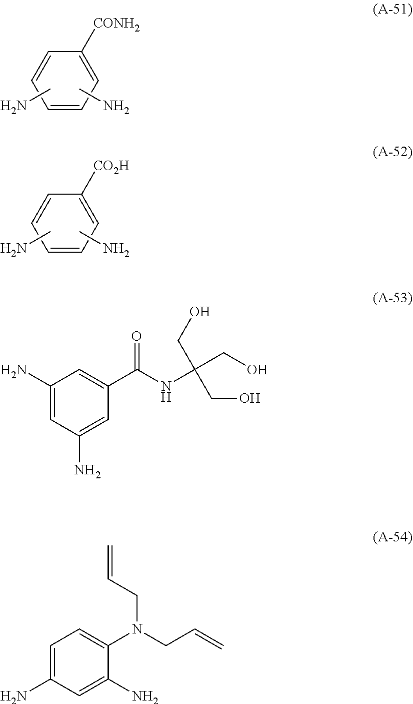

Diamines represented by Formula (A-51) to Formula (A-54) can be suitably used in order to improve the film strength of the alignment film, improve adhesion to a sealing material, and improve adhesion between the alignment film and the substrate. In this case, in order to further improve the above effects, it is most suitable to select a diamine represented by Formula (A-53).

A raw material for producing an alignment film is referred to as an alignment agent. The alignment agent includes a solid content and an organic solvent that dissolves the solid content. An alignment film can be formed by applying the alignment agent to a substrate, removing the solvent, and performing firing as necessary. The solid content contains, as a first component, the polyamic acid, a polyimide or partial polyimide obtained by imidating the polyamic acid, and a polyamic acid ester obtained by esterifying a carboxylic acid residue of the polyamic acid. One having high solubility in an organic solvent among polyimides and partial polyimides is particularly referred to as a soluble polyimide. Such a soluble polyimide and polyamic acid ester can be produced in the same manner as in the methods described in, for example, Japanese Patent No. 5929298 and PCT International Publication No. WO 2013/039168. Here, the first component may include two or more types of polymers which are the same type as or different types selected from the above. Regarding the first component, a mixture of the reacted polymer and an organic solvent can be directly used as an alignment agent component. In addition, a component obtained by collecting a polymer from the reaction mixture and re-dissolving the polymer in an organic solvent can be used as the alignment agent component. The solid content may contain, as a second component, other polymers or low molecular-weight compounds.

In order to improve rubbing resistance of the alignment film and adhesion to the substrate, an alignment film may be produced from an alignment agent to which an epoxy compound is added. Regarding the epoxy compound, known compounds can be used without limitation, and compounds represented by the following Formula (Ep-1) to Formula (Ep-21) can be suitably used. In this case, in order to improve adhesion to the substrate, compounds represented by Formula (Ep-11) to Formula (Ep-21) can be suitably used, and compounds represented by Formula (Ep-15), and Formula (Ep-19) to Formula (Ep-21) can be most suitably used. These epoxy compounds may be used alone or two or more thereof may be used in combination. The amount of this epoxy compound added is preferably 1 to 50 weight %, more preferably 1 to 40 weight %, and still more preferably 1 to 30 weight % with respect to the polyamic acid (including derivatives thereof).

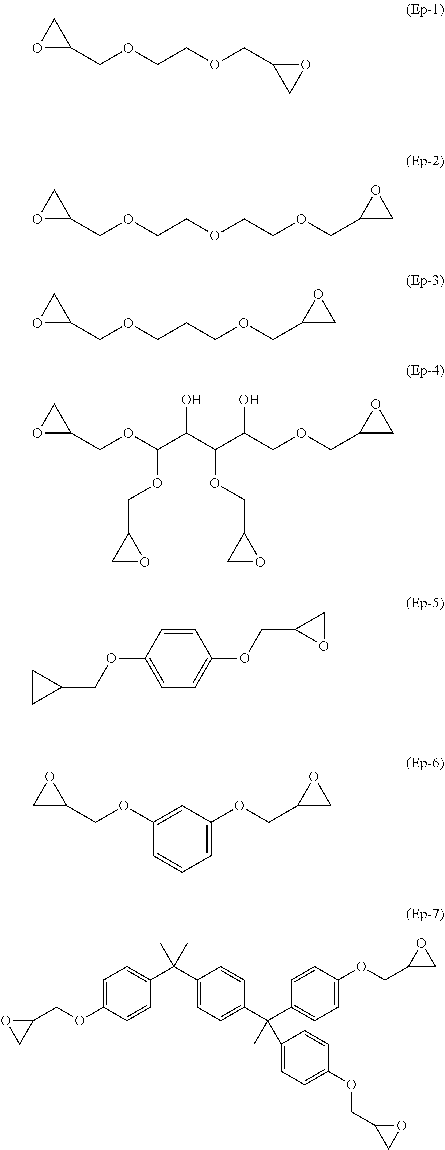

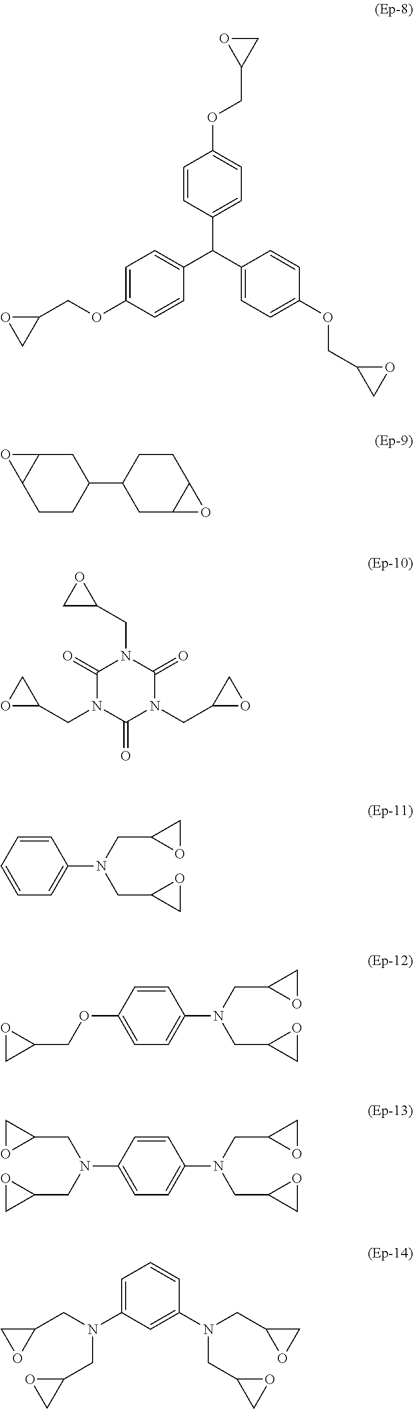

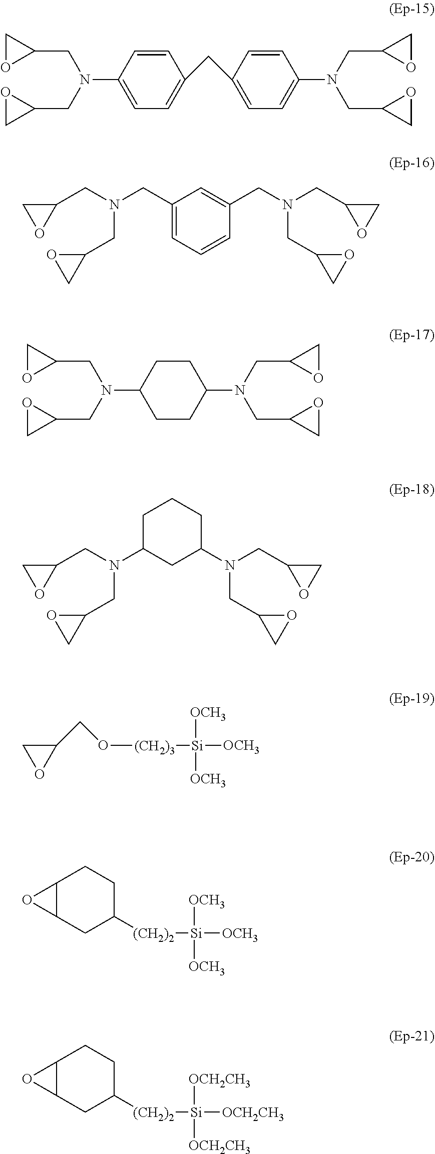

In order to improve rubbing resistance of the alignment film and adhesion to the substrate, an alignment film may be produced from an alignment agent to which a silane coupling agent is added. Examples of silane coupling agents include compounds disclosed in Japanese Patent Laid-Open No. 2013-242526 and the like. Examples of preferable compounds include 3-aminopropyltriethoxysilane. The content of this silane coupling agent is preferably 0.1 to 20 weight %, more preferably 0.1 to 15 weight %, and still more preferably 0.1 to 10 weight % with respect to the polyamic acid.

In order to improve rubbing resistance of the alignment film, an alignment film may be produced from an alignment agent to which an alkenyl-substituted nadimide compound is added. Regarding the alkenyl-substituted nadimide compound, known compounds can be used without limitation, but a compound that is easily dissolved in a solvent for an alignment agent is preferable. Examples of preferable alkenyl-substituted nadimide compounds include bis{4-(allylbicyclo [2.2.1]hept-5-ene-2,3-dicarboximide)phenyl}methane, N,N′-m-xylylene-bis(allylbicyclo [2.2.1]hept-5-ene-2,3-dicarboximide), and N,N′-hexamethylene-bis(allylbicyclo [2.2.1]hept-5-ene-2,3-dicarboximide). The content of this alkenyl-substituted nadimide compound is preferably 1 to 100 weight %, more preferably 1 to 70 weight %, and still more preferably 1 to 50 weight % with respect to the polyamic acid.

In order to improve rubbing resistance of the alignment film and adhesion to the substrate, an alignment film may be produced from an alignment agent to which an oxazine compound is added. Regarding the oxazine compound, a compound which is soluble in a solvent for an alignment agent and has ring-opening polymerizability is preferable. Preferable examples thereof include compounds represented by Formula (OX-3-1) and Formula (OX-3-9) and compounds disclosed in Japanese Patent Laid-Open No. 2013-242526 and the like. The content of this oxazine compound is preferably 0.1 to 50 weight %, more preferably 1 to 40 weight %, and still more preferably 1 to 20 weight % with respect to the polyamic acid.

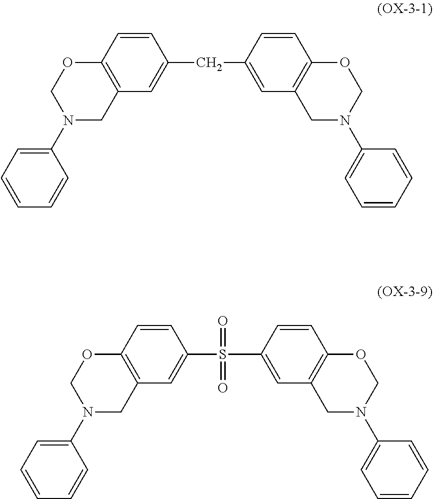 [SMILES: c1ccc(N2COc3ccc(Cc4ccc5c(c4)CN(c4ccccc4)CO5)cc3C2)cc1 ; O=S(=O)(c1ccc2c(c1)CN(c1ccccc1)CO2)c1ccc2c(c1)CN(c1ccccc1)CO2]

In order to improve rubbing resistance of the alignment film and adhesion to the substrate, an alignment film may be produced from an alignment agent to which an oxazoline compound is added. Examples of oxazoline compounds include compounds disclosed in Japanese Patent Laid-Open No. 2013-242526 and the like. Examples of preferable oxazoline compounds include 1,3-bis(4,5-dihydro-2-oxazolyl)benzene. The content of this oxazoline compound is preferably 0.1 to 50 weight %, more preferably 1 to 40 weight %, and still more preferably 1 to 20 weight % with respect to the polyamic acid.

In order to prevent oxidation of a metal electrode such as copper of the element, an alignment film may be produced from an alignment agent to which an anti-rust agent is added. Regarding the anti-rust agent, all known compounds can be used, and regarding preferable compounds, benzotriazole derivatives, benzimidazole derivatives, or benzothiazole derivatives are suitably used. The content of this anti-rust agent is preferably 0.01 to 10 weight %, more preferably 0.01 to 9 weight %, and still more preferably 0.01 to 8 weight % with respect to the polyamic acid.

In order to fire the alignment film at a relatively low temperature of 100° C. to 200° C., an alignment film may be produced from an alignment agent to which an imidization catalyst is added. Examples of imidization catalysts include compounds disclosed in Japanese Patent Laid-Open No. 2013-242526 and the like. The content of this imidization catalyst is 0.01 to 5 equivalents, and preferably 0.05 to 3 equivalents with respect to carbonyl groups of the amic acid.

The epoxy compound, silane coupling agent, alkenyl-substituted nadimide compound, oxazine compound, oxazoline compound, anti-rust agent, and imidization catalyst described above may be used in combination.

The solvent for an alignment agent can be selected from among all commercially available organic solvents in consideration of solubility in the polyamic acid and derivatives thereof and applicability to the substrate. In this case, regarding the solvent having favorable solubility, N-methyl-2-pyrrolidone, N-ethyl-2-pyrrolidone, dimethyl imidazolidinone, N-methyl caprolactam, N-methylpropionamide, N,N-dimethylacetamide, dimethylsulfoxide, N,N-dimethylformamide, N,N-diethylformamide, N,N-diethylacetamide, and lactone such as γ-butyrolactone can be suitably used.

In order to improve applicability, ethylene glycol monoalkyl ethers such as alkyl lactate, 3-methyl-3-methoxybutanol, tetralin, isophorone, phenyl acetate, and ethylene glycol monobutyl ether, diethylene glycol monoalkyl ethers such as diethylene glycol monoethyl ether, propylene glycol monoalkyl ethers such as triethylene glycol monoalkyl ether, propylene glycol monomethyl ether, and propylene glycol monobutyl ether, dialkyl malonates such as diethyl malonate, dipropylene glycol monoalkyl ethers such as dipropylene glycol monomethyl ether, ester compounds such as acetates thereof, and ketone compounds such as diisobutyl ketone can be suitably used.

In order to improve the above characteristics required for the alignment agent, N-methyl-2-pyrrolidone, dimethyl imidazolidinone, γ-butyrolactone, ethylene glycol monobutyl ether, diethylene glycol monoethyl ether, ethylene glycol monomethyl ether, propylene glycol monobutyl ether, propylene glycol monomethyl ether, dipropylene glycol monomethyl ether, or diisobutyl ketone is particularly preferable.

A preferable range of the viscosity of the alignment agent varies depending on an application method, the concentration and type of the solid content, and the type and proportion of the solvent. For example, in the case of application by a printer, the range is preferably 5 to 100 mPa·s because a sufficient film thickness is obtained and it is possible to prevent print unevenness from becoming large, and is more preferably 10 to 80 mPa·s. In the case of application by spin coating, the range is preferably 5 to 200 mPa·s and more preferably 10 to 100 mPa·s. In the case of application using an inkjet application device, the range is preferably 5 to 50 mPa·s, and more preferably 5 to 20 mPa·s. The viscosity of the alignment agent is measured according to a rotational viscosity measurement method and measured using, for example, a rotational viscometer (TVE-20L type, commercially available from Toki Sangyo Co., Ltd.) (measurement temperature: 25° C.).

A dielectric constant of a dielectric substance such as a liquid crystal varies depending on the frequency and the temperature. Therefore, the dependence of such a dielectric constant on the frequency is called a dielectric characteristic of the dielectric substance. When an alternating electric field is applied to a liquid crystal, since the internal electric dipole can follow the change in the electric field as the frequency f increases, the dielectric constant ε′ decreases, and at the same time, the electrical conductivity σ′ increases, and the dielectric loss ε″ may exhibit a peak, and this phenomenon is dielectric relaxation.

In a microwave and millimeter wave range, depending on a frequency range in which measurement is performed, methods of attaching devices and samples are completely different from each other. Up to 10 GHz, an open-ended coaxial type cell is used for a probe because it is easy to analysis an electromagnetic field, and a measurement system including a central network analyzer is assembled in many cases, and a spectrum (dielectric relaxation spectrum) of a complex dielectric constant of a sample is obtained by sweeping the frequency. At several 10 GHz or more, it is necessary to use a waveguide rather than a coaxial cable. In order to calculate the dielectric constant, it is necessary to properly determine boundary conditions when an electromagnetic wave enters a sample, and when the wavelength becomes shorter, more precise processing is necessary accordingly. In a low frequency range, a cell that will become a capacitor is made and a sample is inserted therein, and a dielectric constant is determined from the change in the capacitance.

### EXAMPLES

The disclosure will be described in further detail with reference to examples. The disclosure is not limited to these examples. Unless otherwise specified, examples were performed at room temperature (25° C.).

<Measurement Method>

Measurement and verifying were performed by the following methods. Unless otherwise specified, measurement methods not described in this specification are shown in JEITA⋅ED-2521B.

<DSC Measurement>

Measurement was performed using a differential scanning calorimeter (Diamond DSC commercially available from Perkin Elmer). A transition temperature is indicated in degrees Celsius, which is shown between notations showing a phase. In the notation indicating a phase, C is a crystal layer, N is a nematic phase, S is a smectic phase, and I is an isotropic liquid. In the notation indicating a phase, the description of a phase in the parentheses indicates a monotropic liquid crystal phase.

<Measurement of Molecular Weight>

The weight average molecular weight (Mw) of the polyamic acid and the like was measured according to a GPC method using a 2695 separation module⋅2414 differential refractometer (commercially available from Waters) in terms of polystyrene. The obtained polyamic acid was diluted with a phosphoric acid-DMF mixed solution (phosphoric acid/DMF=0.6/100: weight ratio) so that the concentration of the polyamic acid was about 2 weight %. For the column, HSPgel RT MB-M (commercially available from Waters) was used, the mixed solution was used as a spreading agent, and measurement was performed under conditions of a column temperature of 50° C., and a flow rate of 0.40 mL/min. TSK standard polystyrene (commercially available from Tosoh Corporation) was used as standard polystyrene.

<Upper Limit Temperature of Nematic Phase>

In the examples, “NI” indicates an “upper limit temperature.”

The upper limit temperature was a value of a temperature measured when a sample was placed on a hot plate of a melting point measurement device including a polarized light microscope, heated at a rate of 1° C./min, and a part of the sample was changed from a nematic phase to an isotropic liquid.

<Lower Limit Temperature of Nematic Phase>

In the examples, “Tc” indicates a “lower limit temperature.”

The lower limit temperature was determined when a sample having a nematic phase was put into a glass bottle, stored in a freezer at 0° C., −10° C., −20° C., −30° C., and −40° C. for 10 days, and a phase was observed.

<Refractive Index Anisotropy with Visible Light>

In the examples, the refractive index anisotropy is indicated as “Δn.”

Δn was measured using an Abbe refractometer to which a polarizing plate was attached to an eyepiece.

After the surface of the main prism was rubbed in one direction, the sample was added dropwise to the main prism, a refractive index when a polarized light direction was perpendicular to the rubbing direction was measured as n⊥, and a refractive index when the polarized light direction was parallel to the rubbing direction was measured as n∥. Δn was calculated as Δn=n∥−n⊥.

In this case, light with a wavelength of 589 nm was used and the measurement temperature was 25° C.

<Dielectric Anisotropy at 1 kHz>

The value of dielectric anisotropy was calculated from the formula Δε=ε∥−ε⊥. The dielectric constant (ε∥ and ε⊥) was measured as follows.

(A) Measurement of dielectric constant (ε∥): A methanol (20 mL) solution containing octadecyltriethoxysilane (0.16 mL) was applied to a well-washed glass substrate. The glass substrate was rotated with a spinner and then heated at 150° C. for 1 hour. A sample was inserted into a VA element in which an interval between two glass substrates was 4 μm and the element was sealed with an adhesive that cures with UV light. A sine wave (0.5 V, 1 kHz) was applied to the element, and after 2 seconds, a dielectric constant (ε∥) in a long axis direction of liquid crystal molecules was measured.

(B) Measurement of dielectric constant (ε⊥): A polyimide solution was applied to a well-washed glass substrate. The glass substrate was fired and the obtained alignment film was then rubbed. A sample was inserted into a TN element in which an interval between two glass substrates was 9 μm and a twist angle was 80 degrees. A sine wave (0.5 V, 1 kHz) was applied to the element, and after 2 seconds, a dielectric constant (ε⊥) in a short axis direction of liquid crystal molecules was measured.

<Voltage Holding Ratio (VHR)>

A pulse voltage (at +5 V for 60 microseconds) was applied to a liquid crystal cell by AC driving. A voltage held by the cell was measured by a high-speed voltmeter and plotted with respect to time. Subsequently, a pulse voltage (at −5 V for 60 microseconds) in which the polarity was switched was applied, and the voltage held by the cell was similarly plotted. An area between the voltage curve and the horizontal axis was calculated for each of the positive and negative pulse voltages, and an average value was defined as an area A. When the area when a voltage was not attenuated was defined as B, a percentage of the area A with respect to the area B was calculated, and defined as VHR. Measurement was performed by setting the holding time after the pulse voltage was applied as 16.7 milliseconds and 1.67 seconds, and these values were defined as VHR1 and VHR2. The measurement was performed in a constant temperature oven, and the temperature was 60° C.

<Refractive Index Anisotropy, Dielectric Anisotropy and Dielectric Loss at 50 GHz>

Measurement was performed according to the method disclosed in Applied Optics, Vol. 44, No. 7, p 1150 (2005). For the refractive index anisotropy, a liquid crystal was filled into a V band adjustable short-circuited waveguide to which a window material was attached and left in a static magnetic field of 0.3 T for 3 minutes. A microwave of 50 GHz was input to the waveguide and an amplitude ratio of reflected waves to incident waves was measured. Measurement was performed by changing the direction of the static magnetic field and the tube length of the short-circuit device, and refractive indexes (ne, no) and loss parameters (αe, αo) were determined. The refractive index anisotropy (Δn) was calculated by ne-no.

The dielectric anisotropy was calculated as (Δε)=ε∥′−ε⊥′ and the dielectric loss was calculated as (tan δ)=ε″/ε′ using complex dielectric constants (ε′, ε″). In order to calculate the complex dielectric constant, the refractive indexes and loss parameters calculated above and the following relational formulae were used.

Here, c is the speed of light in vacuum. A larger value was used since the anisotropy appeared in dielectric loss.

ε′=n²−κ²

ε″=2nκ

α=2ωc/κ

<Measurement of Relative Dielectric Constant of Alignment Film>

A 4284A precision LCR meter (commercially available from Agilent Technologies) was used. A sine wave with a voltage of 1.0 V and a frequency of 1.0 kHz was applied and a capacitance of a measurement substrate was measured. Calculation was performed using the obtained capacitance, film thickness and electrode area. The film thickness of the alignment film was measured using a spectroscopic ellipsometer M-2000 (registered trademark, commercially available from J.A. Woollam Japan).

<Bulk Viscosity>

In the examples, the bulk viscosity of the composition is indicated as “r.” The bulk viscosity was measured using an E type rotational viscometer (commercially available from Tokyo Keiki Co., Ltd.). A measurement temperature was 20° C.

<Measurement of Imidation Rate>

20 mg of polyimide powder was put into an NMR tube, and dissolved in 0.55 m1 of deuterated dimethyl sulfoxide (99.9 atom % D, 0.03% TMS, commercially available from SIGMA-ALDRICH). This solution was subjected to NMR measurement. The imidation rate was obtained as follows.

Imidation rate (%)=(1−BHb/BHa·NHa/NHb)×100

BHb: an integrated value of proton derived from a structure that does not change before and after imidization (before imidization)

BHa: an integrated value of proton derived from a structure that does not change before and after imidization (after imidization)

NHb: an integrated value of proton derived from an NH group of amic acid appearing at 9 to 10 ppm (before imidization)

NHa: an integrated value of proton derived from an NH group of amic acid appearing at 9 to 10 ppm (after imidization)

NMR was measured using DRX-500 (commercially available from Bruker BioSpin). A cumulative number of measurements was 100.

<Rubbing>

Rubbing was performed using a rubbing treatment device (commercially available from Iinuma Gauge Manufacturing Co., Ltd.) under conditions of a hair length push-in amount of 0.40 mm of a rubbing cloth (hair length 2.8 mm: cotton), a stage moving speed of 20 mm/sec, and a roller rotation speed of 1,000 rpm. The substrate after rubbing of which surface was washed with ultrapure water was dried in an oven at 120° C. for 30 minutes, and then used.

<Optical Alignment Treatment 1>

UV linearly polarized light was emitted to a polyimide film via a polarizing plate in a direction perpendicular to the substrate using Multi Light ML-501C/B (commercially available from Ushio Inc). For exposure energy at this time, a light intensity was measured using Accumulated UV Meter UIT-250 (optical receiver: UVD-S365, commercially available from Ushio Inc) and the exposure time was adjusted so that the energy density was 2.0±0.1 J/cm² at a wavelength of 365 nm.

<Optical Alignment Treatment 2>

UV linearly polarized light was emitted to a polyimide film via a polarizing plate in a direction perpendicular to the substrate using multi Light ML-501C/B (commercially available from Ushio Inc). For exposure energy at this time, a light intensity was measured using Accumulated UV Meter UIT-250 (optical receiver: UVD-S254, commercially available from Ushio Inc) and the exposure time was adjusted so that the energy density was 0.3±0.1 J/cm² at a wavelength of 254 nm. The substrate was immersed in a 50% isopropanol aqueous solution at 25° C. for 5 minutes, and then immersed in pure water at 25° C. for 1 minute, and dried in an oven at 230° C. for 15 minutes.

The alignment film was prepared using the following raw materials.

### <Tetracarboxylic Dianhydride>

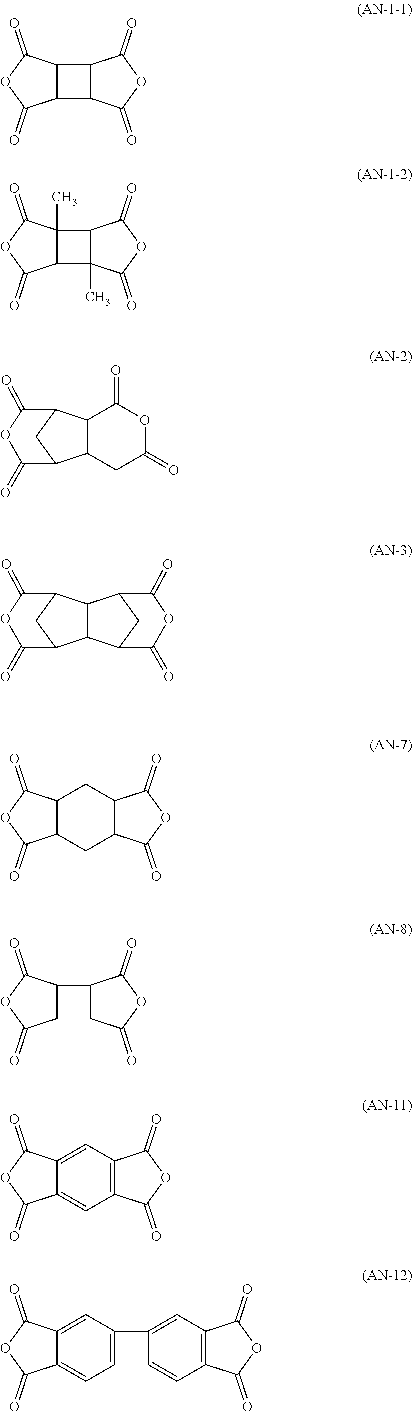

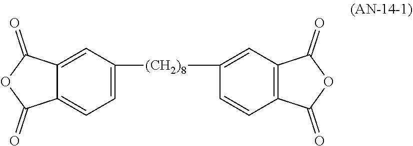

### <Diamine>

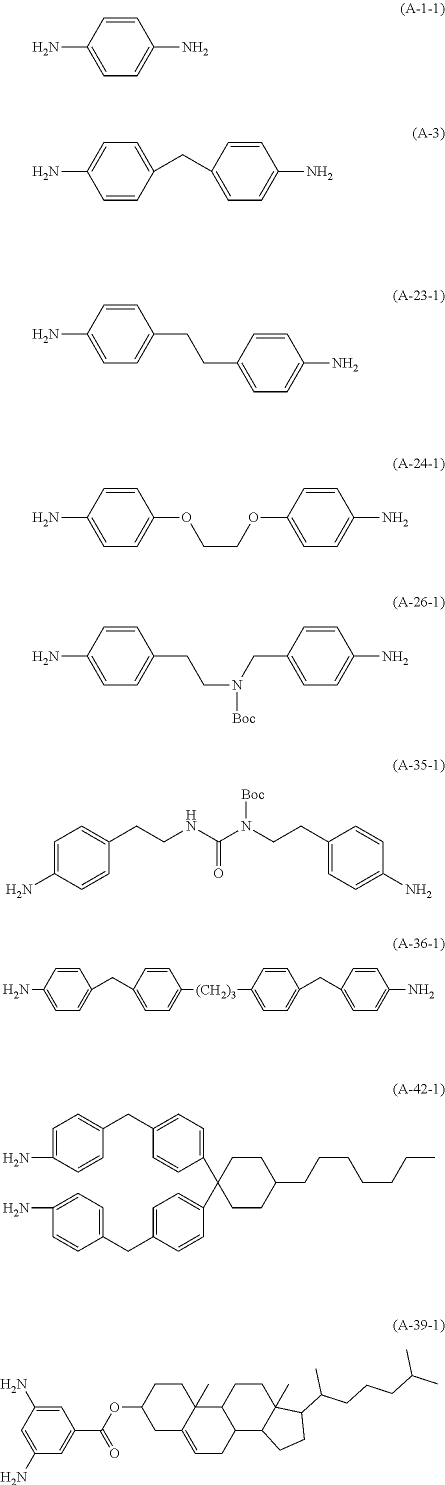

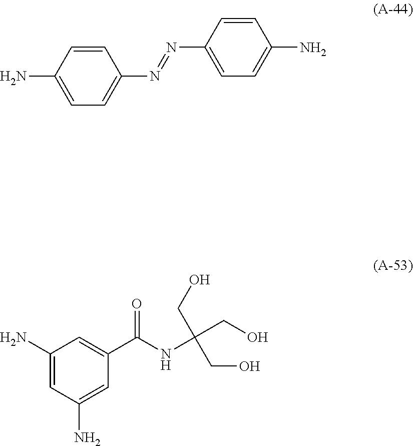 [SMILES: Nc1ccc(/N=N/c2ccc(N)cc2)cc1 ; Nc1cc(N)cc(C(=O)NC(CO)(CO)CO)c1]

### <Other Additives>

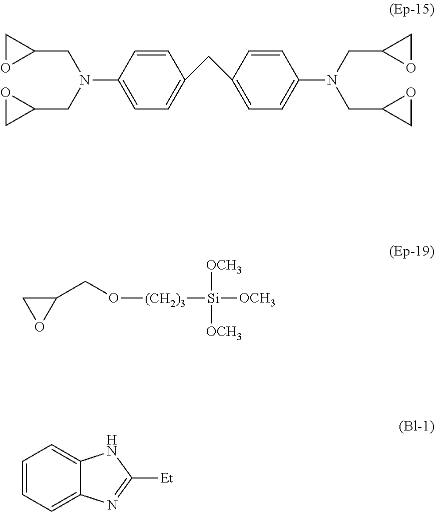

### <Silane Coupling Agent>

C-1: 3-aminopropyltriethoxysilane

### <Solvent>

NMP: N-methyl-2-pyrrolidone

BC: butyl cellosolve (ethylene glycol monobutyl ether)

GBL: γ-butyrolactone

### [Synthesis Example 1] Preparation of Varnish 1

2.9345 g (14.80 mmol) of a compound represented by Formula (A-3) was put into a 100 mL 3-neck flask having a stirring blade and a nitrogen inlet tube attached thereto and 54.0 g of NMP was added thereto. The solution was ice-cooled so that the liquid temperature became 5° C. Then, 1.7306 g (8.825 mmol) of a compound represented by Formula (AN-1-1), 1.0491 g (5.295 mmol) of a compound represented by Formula (AN-8), 0.7700 g (3.530 mmol) of a compound represented by Formula (AN-11), and 20.0 g of NMP were added thereto, and stirring was performed at room temperature for 12 hours. 20.0 g of BC was added thereto, and the solution was heated and stirred at 70° C. until the weight average molecular weight of the solute polymer became a desired weight average molecular weight, and thereby an alignment agent 1 with a solid content of 6 wt % was obtained. The viscosity of the varnish 1 was 36.4 mPa·s, and the weight average molecular weight (Mw) of the polymer contained in the varnish was 55,000.

### Synthesis Examples 2 to 12

Varnish 2 to varnish 12 with a polymer solid content concentration of 6 weight % were prepared in the same manner as in Synthesis Example 1 except that diamines and tetracarboxylic dianhydrides were changed. The compositions of the obtained varnishes are shown in Table 1-1, and the viscosity and the weight average molecular weight of these varnishes are shown in Table 1-2. Synthesis Example 1 is also shown. The value in parentheses [ ] indicates a molar ratio in each of the diamine compound group and tetracarboxylic acid compound group.

TABLE 1-1

| Synthesis Example | | |
|---|---|---|
| varnish | Diamine | Acid anhydride |
| 1 | A-3 [100] | AN-1-1 [50] |
| | | AN-8 [30] |
| | | AN-11 [20] |
| 2 | A-3 [100] | AN-1-1 [30] |
| | | AN-7 [20] |
| | | AN-11 [50] |
| 3 | A-1-1 [50] | AN-1-1 [70] |
| | A-3 [50] | AN-11 [30] |
| 4 | A-1-1 [20] | AN-3 [30] |
| | A-24-1 [80] | AN-12 [70] |
| 5 | A-3 [10] | AN-1-1 [60] |
| | A-36-1 [90] | AN-8 [25] |
| | | AN-11 [15] |
| 6 | A-24-1 [50] | AN-1-1 [50] |
| | A-35-1 [50] | AN-11 [50] |
| 7 | A-23-1 [50] | AN-1-1 [80] |
| | A-42-1 [50] | AN-11 [20] |
| 8 | A-3 [85] | AN-1-1 [60] |
| | A-39-1 [15] | AN-2 [40] |
| 9 | A-44 [97] | AN-1-1 [50] |
| | A-53 [3] | AN-14-1 [50] |
| 10 | A-1-1 [50] | AN-8 [65] |
| | A-3 [50] | AN-11 [35] |
| 11 | A-3 [10] | AN-8 [30] |
| | A-36-1 [90] | AN-11 [70] |
| 12 | A-44 [97] | AN-14-1 [100] |
| | A-53 [3] | |

TABLE 1-2

| Synthesis Example | Varnish viscosity | Weight average |
|---|---|---|
| varnish | (mPa · s) | molecular weight |
| 1 | 36.4 | 55,000 |
| 2 | 37.5 | 63,000 |
| 3 | 35.8 | 54,000 |
| 4 | 34.4 | 48,000 |
| 5 | 35.2 | 72,000 |
| 6 | 32.1 | 58,000 |
| 7 | 34.0 | 68,000 |
| 8 | 15.4 | 23,000 |
| 9 | 12.2 | 11,000 |
| 10 | 35.8 | 49,000 |
| 11 | 37.7 | 71,000 |
| 12 | 11.3 | 12,000 |

### [Synthesis Example 13] Preparation of Polyimide Varnish 1

4.3464 g (17.79 mmol) of a compound represented by Formula (A-24-1), and 6.0753 g (17.79 mmol) of a compound represented by Formula (A-26-1) were put into a 200 mL 3-neck flask having a stirring blade and a nitrogen inlet tube attached thereto and 59.6 g of NMP was added thereto. The solution was ice-cooled so that the liquid temperature became 5° C. Then, 7.5783 g (33.81 mmol) of a compound represented by Formula (AN-1-2) and 22.4 g of NMP were added thereto, and stirring was performed at room temperature for 12 hours.

50 g of NMP was added to the obtained polyamic acid solution, and 10.8 g of acetic anhydride and 2.4 g of pyridine were added thereto, and stirring was performed at 60° C. for 3 hours. After cooling, a reaction solution was put into the stirred methanol (312 g) and the deposited precipitate was filtered off. The obtained solid was washed with 312 g of methanol three times and 624 g of methanol twice, and the obtained powder was dried at 60° C. for 12 hours to obtain a polyimide powder (yield 89%). The weight average molecular weight of the polyimide powder was 17,000, and the imidation rate was 71%. 6 g of the polyimide powder was put into a sample bottle, NMP (94 g) was added thereto, stirring was performed at 70° C. for 10 hours, and thereby a polyimide varnish 1 was obtained. The viscosity of the polyimide varnish 1 was 13.1 mPa·s.

[Liquid Crystal Alignment Agent]

The varnishes obtained in the above synthesis examples were mixed at ratios shown in the following Table 2, and thereby alignment agents 1 to 10 were obtained. The alignment agents 8 to 10 were used as comparative examples because an acid dianhydride used in varnishes 10 to 12 was composed of only a material having the structure for R³ in Formula (2) and having no alicyclic structure. In the following table, the mixing ratio between varnishes is a weight ratio. Additives are shown in weight % with respect to the total solid content weight of the varnish. These values are shown in [ ].

TABLE 2

| Alignment agent | Varnish | | Additive |
|---|---|---|---|
| 1 | 5 [100] | | C-1 [1.0 wt %] |
| 2 | 6 [100] | | |
| 3 | 7 [8] | 1 [92] | C-1 [0.5 wt %] |
| 4 | 7 [8] | 1 [92] | C-1 [0.5 wt %] |
| | | | BI-1 [0.01 wt %] |
| 5 | 8 [20] | 2 [80] | Ep-15 [3.0 wt %] |
| 6 | 9 [30] | 3 [70] | Ep-19 [2.0 wt %] |
| 7 | Polyimide varnish 1 | 4 [66] | |
| | [34] | | |
| 8 | 11 [100] | | C-1 [1.0 wt %] |
| 9 | 12 [20] | 3 [80] | Ep-19 [2.0 wt %] |
| 10 | 12 [20] | 10 [80] | Ep-19 [2.0 wt %] |

<Liquid Crystal Composition>

Liquid crystal compounds were mixed to prepare a composition. The structures of the liquid crystal compounds were represented according to expressions in Table 3. Unless otherwise specified, the divalent group of the six-membered ring in Table 3 had a trans configuration. The number in parentheses after the compound shown in the liquid crystal composition represents a chemical formula to which the compound belongs. The symbol (−) refers to other liquid crystal compounds. The proportion of the liquid crystal compound is a weight percentage based on the weight of the liquid crystal composition containing no additives.

TABLE 3
Symbols for framework of liquid crystal compound
R—(A₁)—Z₁—Zₙ—(Aₙ)—R′

| Left terminal | Sym- | Right terminal | Sym- |
|---|---|---|---|
| group R— | bol | group —R' | bol |
| CₙH₂ₙ₊₁— | n— | —CₙH₂ₙ₊₁ | —n |
| CₙH₂ₙ₊₁O— | nO— | —OCₙH₂ₙ₊₁ | —On |
| CₘH₂ₘ₊₁OCₙH₂ₙ— | mOn— | —CₙH₂ₙOCₘH₂ₘ₊₁ | —nOm |
| CH₂═CH— | V— | —CH═CH₂ | —V |
| CₙH₂ₙ₊₁—CH═CH— | nV— | —CH═CHCₙH₂ₙ₊₁ | —Vn |
| CH₂═C—CₙH₂ₙ— | Vn— | —CₙH₂ₙ—C═CH₂ | —nV |
| CₘH₂ₘ₊₁—CH═C— | mVn— | —CₙH₂ₙ—C═CH— | —nVm |
| CₙH₂ₙ— | | CₘH₂ₘ₊₁ | |
| CF₂═CH— | VFF— | —CH═CF2 | —VFF |
| CF₂═CH—CₙH₂ₙ— | VFFn— | —CₙH₂ₙ—CH═CF₂ | —nVFF |
| CₙH₂ₙ₊₁S— | nS— | —SCₙH₂ₙ₊₁ | —Sn |
| | | —F | —F |
| | | —Cl | —Cl |
| | | —OCF₃ | —OCF₃ |
| | | —CF₃ | —CF₃ |
| | | —CN | —C |
| | | —NCS | —NCS |

| Linking group —Zₙ— | Symbol |
|---|---|
| —CF₂O— | X |
| —C≡C— | T |
| —C≡C—C≡C— | TT |
| —CH₂CH₂— | 2 |
| —COO— | E |
| —CH₂O— | 1O |
| —C═C— | V |

Ring structure

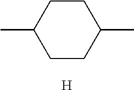

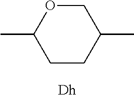

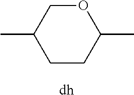

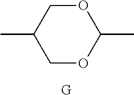

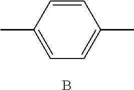

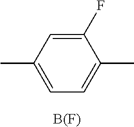

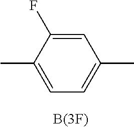

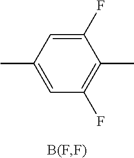

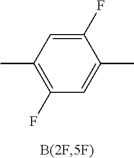

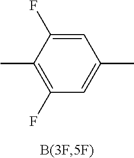

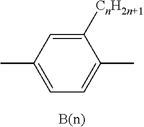

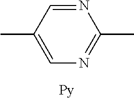

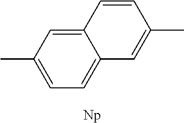

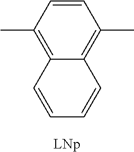

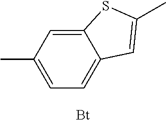

Expression example of liquid crystal compound

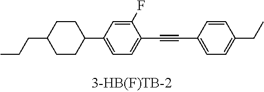 [SMILES: CCCC1CCC(c2ccc(C#Cc3ccc(CC)cc3)c(F)c2)CC1]

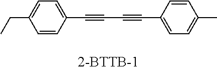 [SMILES: CCc1ccc(C#CC#Cc2ccc(C)cc2)cc1]

### Preparation Example 1

Preparation and physical properties of liquid crystal composition 1

| | | |
|---|---|---|
| 3-HB (F)TB-2 | (1-1-9) | 5% |
| 3-HB (F)TB-3 | (1-1-9) | 4% |
| 3-BB (F)TB-2 | (1-1-13) | 4% |
| 3-BB (F)TB-3 | (1-1-13) | 4% |
| 3-BB (F)TB-4 | (1-1-13) | 4% |
| 2-BTTB-1 | (1-1-30) | 10% |
| 3-BTTB-1 | (1-1-30) | 10% |
| 5-BTTB-1 | (1-1-30) | 10% |
| 3-BB (F,F)XB (F,F)-F | (1-2-2) | 13% |
| 3-GB (F,F)XB (F,F)-F | (1-2-4) | 6% |
| 3-BB (F)B (F,F)XB (F,F)-F | (1-2-6) | 2% |
| 4-BB (F)B (F,F)XB (F,F)-F | (1-2-6) | 8% |
| 5-BB (F)B (F,F)XB (F,F)-F | (1-2-6) | 6% |
| 4-GB (F)B (F)XB (F,F)-F | (1-2-9) | 4% |
| 5-GB (F)B (F)XB (F,F)-F | (1-2-9) | 4% |
| 3-BB (F,F)XB (F)B (F,F)-F | (1-2-12) | 6% |

NI = 119° C.; Tc <- 20° C.; Δn = 0.322; Δε = 11.3; η = 48.1 mPa · s

The dielectric anisotropy and the dielectric loss at 50 GHz of liquid crystal composition 1 were as follows.

Dielectric anisotropy: 0.76

Dielectric loss: 0.009

### Preparation Example 2

Preparation and physical properties of liquid crystal composition 2

| | | |
|---|---|---|
| 3-BBTB (3F,5F)-2 | (1-1-12) | 20% |
| 3-BBTB (3F,5F)-4 | (1-1-12) | 36% |
| 5-HBB (F)B-2 | (1-3-23) | 7% |
| 5-HBB (F)B-3 | (1-3-23) | 7% |
| 3-B (F)B (F)B-Cl | (1-3-29) | 10% |
| 5-B (F)B (F)B-Cl | (1-3-29) | 20% |

NI = 173.0° C.; Δn = 0.335; Δε = 4.6; η = 78.2 mPa ·s

The dielectric anisotropy and dielectric loss at 50 GHz of the liquid crystal composition 2 were as follows.

Dielectric anisotropy: 0.81

Dielectric loss: 0.010

[Production of Liquid Crystal Cell (AP Cell)]

3.0 g of an alignment agent was weighed out, and a solution in which NMP/GBL/BC were mixed at 4/3/3 (weight ratio) was added thereto and 6.0 g was obtained. The diluted alignment agent was applied to an ITO surface of a glass substrate with ITO by a spinner method (2,000 rpm, 15 seconds). After coating, preliminary firing was performed at 80° C. for 3 minutes, and firing was then performed at 210° C. for 30 minutes, and a film with a film thickness of about 100 nm was formed. The obtained film was rubbed. Next, in two substrates on which such an alignment film was formed, surfaces on which the alignment film was formed were made to face each other and a space for injecting a liquid crystal composition was provided between the alignment films facing each other, and bonded with a thermosetting sealant (with a curing temperature of 170° C. for 30 minutes). In this case, rubbing directions of the alignment films were antiparallel, and the space was ensured by spraying a bead spacer (3.8 μm) to a sealant and the substrate. The liquid crystal composition 1 was vacuum-injected into these cells, an inlet was sealed with a light curing agent, and a liquid crystal cell with a cell thickness of 4 μm (AP cell; anti-parallel cell) was produced.

[Production of Liquid Crystal Cell (VA Cell)]

A liquid crystal cell with a cell thickness of 4 μm (VA cell) was produced in the same manner as in the production of the AP cell except that rubbing was omitted.

[Production of Liquid Crystal Cell (Optical Alignment Cell 1)]

An alignment agent was applied by a spinner method in the same manner as in the production of the AP cell. After coating, preliminary firing was performed at 80° C. for 3 minutes, and the optical alignment treatment 1 was then performed. Then, firing was performed at 210° C. for 30 minutes, and an alignment film with a film thickness of about 100 nm was formed. In the same manner as in the production of the AP cell, two substrates on which such an alignment film was formed were used to assemble a cell. In this case, in respective alignment films, directions in which linearly polarized light was emitted were parallel, and a space was ensured by spraying a bead spacer (3.8 μm) to a sealant and the substrate. The liquid crystal composition 1 was vacuum-injected into these cells, an inlet was sealed with a light curing agent, and a liquid crystal cell with a cell thickness of 4 μm (optical alignment cell 1) was produced.

[Production of Liquid Crystal Cell (Optical Alignment Cell 2)]

An alignment agent was applied by a spinner method in the same manner as in the production of the AP cell. After coating, preliminary firing was performed at 80° C. for 3 minutes, and firing was then performed at 230° C. for 15 minutes. Then, the optical alignment treatment 2 was performed and an alignment film with a film thickness of about 100 nm was formed. In the same manner as in the production of the optical alignment cell 1, a liquid crystal cell with a cell thickness of 4 μm (optical alignment cell 2) was produced using two substrates on which such an alignment film was formed.

### Examples 1 to 7 and Comparative Examples 1 to 3

The above liquid crystal cells were produced using the alignment agents 1 to 10. The VHR of the produced cells is shown in the following Table 4 and Table 5.

TABLE 4

| | Liquid crystal | | Alignment | | |
|---|---|---|---|---|---|
| | cell | Type of liquid | agent | VHR1 | VHR2 |
| Example | No. | crystal cell | No. | [%] | [%] |
| 1 | 1 | AP cell | 1 | 99.4 | 94.1 |
| 2 | 2 | AP cell | 2 | 99.4 | 94.5 |
| 3 | 3 | AP cell | 3 | 99.3 | 93.9 |
| 4 | 4 | AP cell | 4 | 99.2 | 93.7 |
| 5 | 5 | VA cell | 5 | 99.0 | 92.1 |
| 6 | 6 | Optical alignment | 6 | 99.1 | 92.3 |
| | | cell 1 | | | |
| 7 | 7 | Optical alignment | 7 | 99.1 | 92.4 |
| | | cell 2 | | | |

TABLE 5

| | Liquid | | | | |
|---|---|---|---|---|---|
| | crystal | | Alignment | | |
| Comparative | cell | Type of liquid | agent | VHR1 | VHR2 |
| Example | No. | crystal cell | No. | [%] | [%] |
| 1 | ref. 1 | AP cell | 8 | 98.8 | 90.2 |
| 2 | ref. 2 | Optical alignment | 90 | 98.4 | 89.2 |
| | | cell 1 | | | |
| 3 | ref. 3 | Optical alignment | 10 | 98.7 | 90.3 |
| | | cell 2 | | | |

### Examples 8 to 10

Liquid crystal cells were produced using alignment agents 1, 3, and 6, and the liquid crystal composition 2. The VHR of the produced cells is shown in the following Table 6.

TABLE 6

| | Liquid crystal | | Alignment | | |
|---|---|---|---|---|---|
| | cell | Type of liquid | agent | VHR1 | VHR2 |
| Example | No. | crystal cell | No. | [%] | [%] |
| 8 | 8 | AP cell | 1 | 99.3 | 94.4 |
| 9 | 9 | AP cell | 3 | 99.2 | 93.2 |
| 10 | 10 | Optical alignment | 6 | 99.2 | 93.7 |
| | | cell 1 | | | |

Comparing the above examples and comparative examples, it can be understood that the liquid crystal element of the disclosure had large dielectric anisotropy and low dielectric loss in a high frequency range and also had a high VHR.

The element of the disclosure can be used for phase control of an electromagnetic wave signal with a frequency of 1 MHz to 400 THz.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An element which is used for phase control of an electromagnetic wave signal with a frequency of 1 MHz to 400 THz, and comprises a polyimide alignment film for alignment control of a liquid crystal composition,
wherein the liquid crystal composition contains a compound represented by the following Formula (1), and has a refractive index anisotropy of 0.30 or more at a wavelength of 589 nm, and
wherein the polyimide alignment film contains 10% or more of a repeating unit represented by the following Formula (2) with respect to all repeating units: 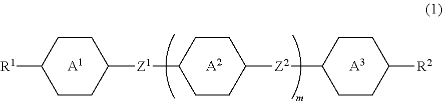
in Formula (1), R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom,
the rings A¹, A² and A³ independently represent one selected from among groups represented by the following Formula (I) to Formula (XXXVI), 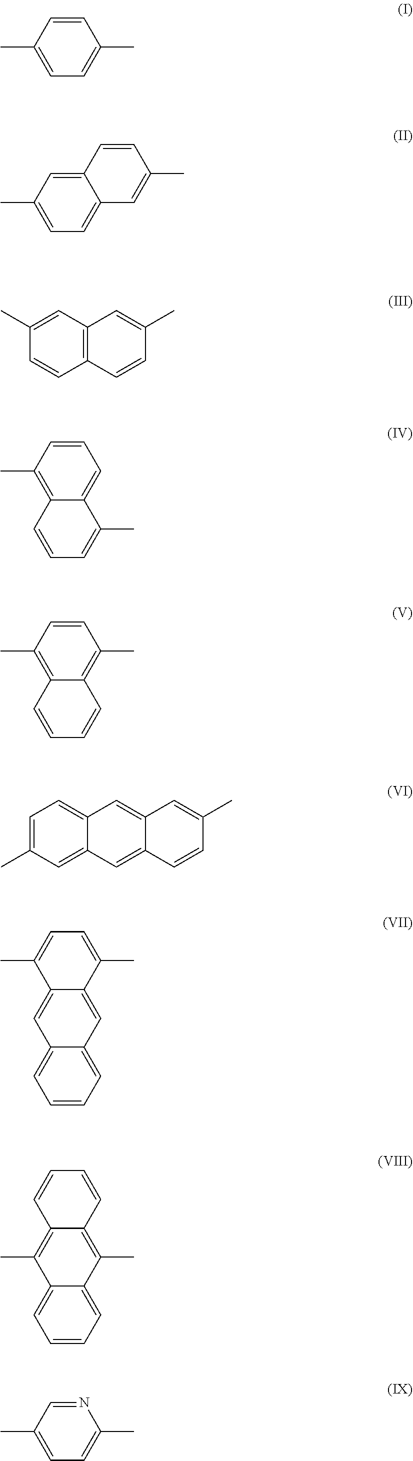 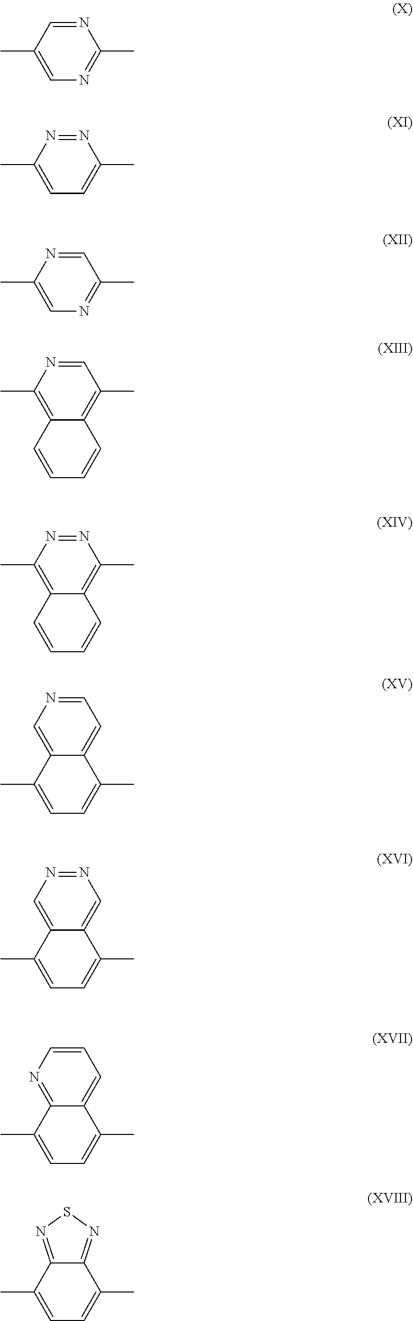 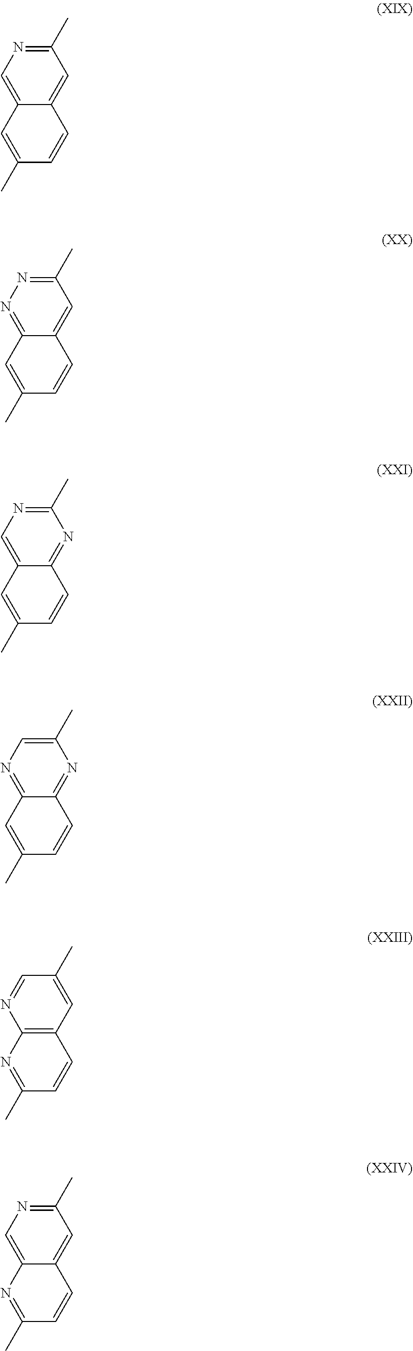 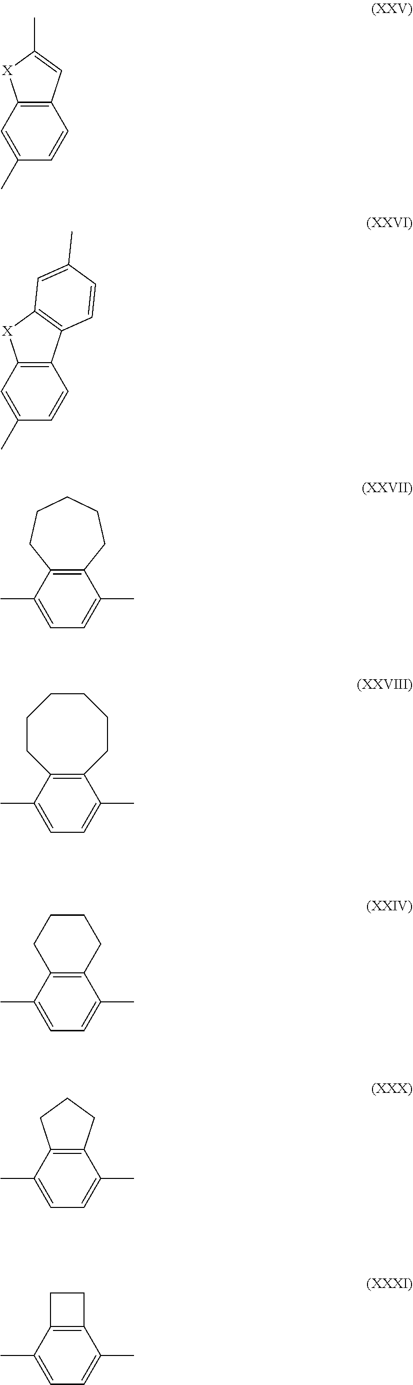 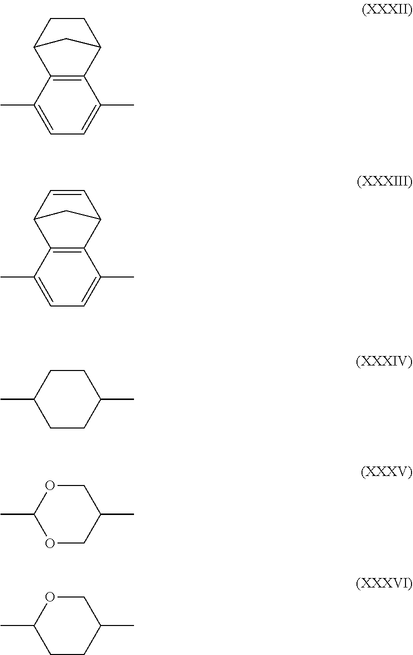
in the groups represented by Formula (I) to Formula (XXXVI), one or more hydrogen atoms may be substituted with a fluorine atom, an alkyl group having 1 to 5 carbon atoms, or a cycloalkyl group having 3 to 6 carbon atoms,
X is —NH— or —S—,
Z¹ and Z² independently represent a single bond, —CH₂CH₂—, —CH═CH—, —CF═CF—, —CH═CF—, —CH₂O—, —COO—, —CF₂CF₂—, —C≡C—, —C≡C—C≡C—, or —CF₂O—,
m represents an integer of 0 to 5, and when m is 2 to 5, a plurality of rings A² and Z² may be the same as or different from each other;
R² represents the above R¹, —CN, —F, —Cl, —CF₃, —OCF₃, —CF₂H, —OCF₂H, —NCS, or —SF₅, and 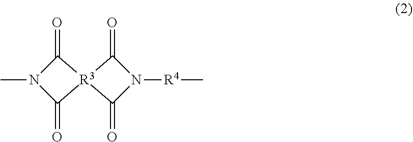
in Formula (2), R³ represents a tetravalent group having an alicyclic structure, and R⁴ represents a divalent organic group having 2 to 50 carbon atoms.

2. The element according to claim 1, wherein R³ in Formula (2) is one selected from among groups represented by the following Formula (2-1) to Formula (2-3): 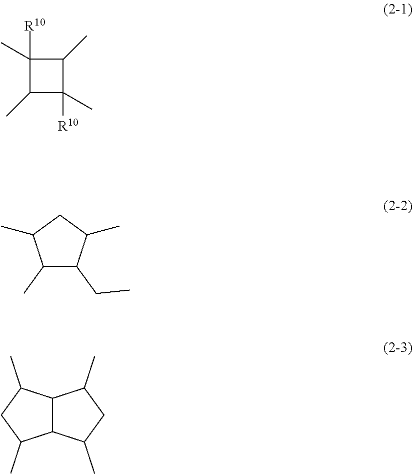
in Formula (2-1), R¹⁰'s each independently represent a hydrogen atom, —CH₃, —CH₂CH₃, or a phenyl group.

3. The element according to claim 1, wherein the compound represented by Formula (1) is a compound in which Z¹ is —CH═CH—, —CF═CF—, —CH═CF—, —C≡C—, or —C≡C—C≡C—, the rings A¹ and A² are one selected from among groups represented by Formula (I) to Formula (XXXIII), the ring A³ is one selected from among groups represented by Formula (I) to Formula (XXXVI), and m represents an integer of 0 to 2.

4. The element according to claim 1, wherein the compound represented by Formula (1) is a compound in which one or two selected from among Z¹ and Z² are —CF₂O—, m represents an integer of 0 to 2, and R² is —CN, —F, —CF₃, —OCF₃, —CF₂H, —OCF₂H, —N═C═S, or —SF₅.

5. The element according to claim 1, wherein the compound represented by Formula (1) is a compound in which Z¹ and Z² are a single bond, m represents an integer of 0 to 2, and R² is —CN, —F, —CF₃, —OCF₃, —CF₂H, —OCF₂H, —N═C═S, or —SF₅.

6. The element according to claim 1, wherein the compound represented by Formula (1) is a compound represented by the following Formula (1-1): 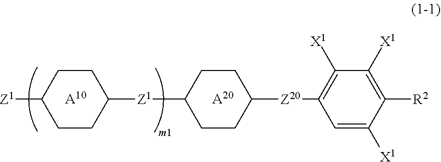
in Formula (1-1), Z¹ represents a single bond, —CH₂CH₂—, —CH═CH—, —CF═CF—, —CH═CF—, —CH₂O—, —COO—, —CF₂CF₂—, —C≡C—, —C≡C—C≡C—, or —CF₂O—, and Z²⁰ is —C≡C— or —C≡C—C≡C—, the ring A¹⁰ is a group represented by Formula (I), (II), (V), (VI), (IX), (X), (XI), (XXV), (XXVI), (XXXIV), (XXXV), or (XXXVI), the ring A²⁰ is a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,
R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom;
X¹'s independently represent a hydrogen atom or a fluorine atom,
m1 represents an integer of 0 to 2, and when m1 is 2, a plurality of rings A¹⁰ and Z¹ may be the same as or different from each other; and
R² represents the above R¹, —CN, —F, —Cl, —CF₃, —OCF₃, —CF₂H, —OCF₂H, —N═C═S, or —SF₅.

7. The element according to claim 1, wherein the compound represented by Formula (1) is a compound represented by the following Formula (1-2): 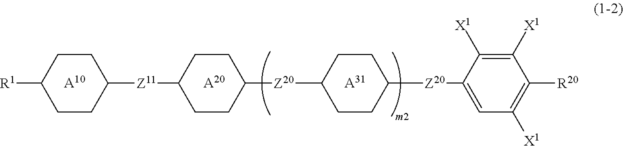
in Formula (1-2), the ring A¹⁰ is a group represented by Formula (I), (II), (V), (VI), (IX), (X), (XI), (XXV), (XXVI), (XXXIV), (XXXV), or (XXXVI), the rings A²⁰ and A³¹ independently represent a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,
Z¹¹ represents a single bond, —CH₂CH₂—, —CH═CH—, —CF═CF—, —CH═CF—, —CH₂O—, —COO—, —CF₂CF₂—, or —C≡C—, Z²⁰ is —CF₂O—, and when there are two or more Z²⁰'s, one is —CF₂O—, and the other represents a single bond, —CH₂CH₂—, —CH═CH—, —CH₂O—, —COO—, —CF₂CF₂—, or —C≡C—,
X¹'s independently represent a hydrogen atom or a fluorine atom,
m2 is 0 or 1,
R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and
R²⁰ is —CN, —F, —Cl, —CF₃, —OCF₃, —CF₂H, —OCF₂H, —N═C═S, or —SF₅.

8. The element according to claim 1, wherein the compound represented by Formula (1) is a compound represented by the following Formula (1-3): 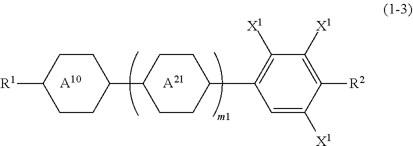
in Formula (1-3), the ring A¹⁰ is a group represented by Formula (I), (II), (V), (VI), (IX), (X), (XI), (XXV), (XXVI), (XXXIV), (XXXV), or (XXXVI), the ring A² is a group represented by Formula (I), (II), (V), (VI), (IX), (X), (XI), (XXV), or (XXVI), and one or more hydrogen atoms on the above (I) may be substituted with a fluorine atom or an alkyl group having 1 to 5 carbon atoms,
X¹'s independently represent a hydrogen atom or a fluorine atom,
m1 represents an integer of 0 to 2, and when m1 is 2, a plurality of ring A²¹'s may be the same as or different from each other;
R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and
R² represents the above R¹, —CN, —F, —Cl, —CF₃, —OCF₃, —CF₂H, —OCF₂H, —N═C═S, or —SF₅.

9. The element according to claim 6, wherein the compound represented by Formula (1-1) is one selected from among compounds represented by the following Formula (1-1-1) to Formula (1-1-41): 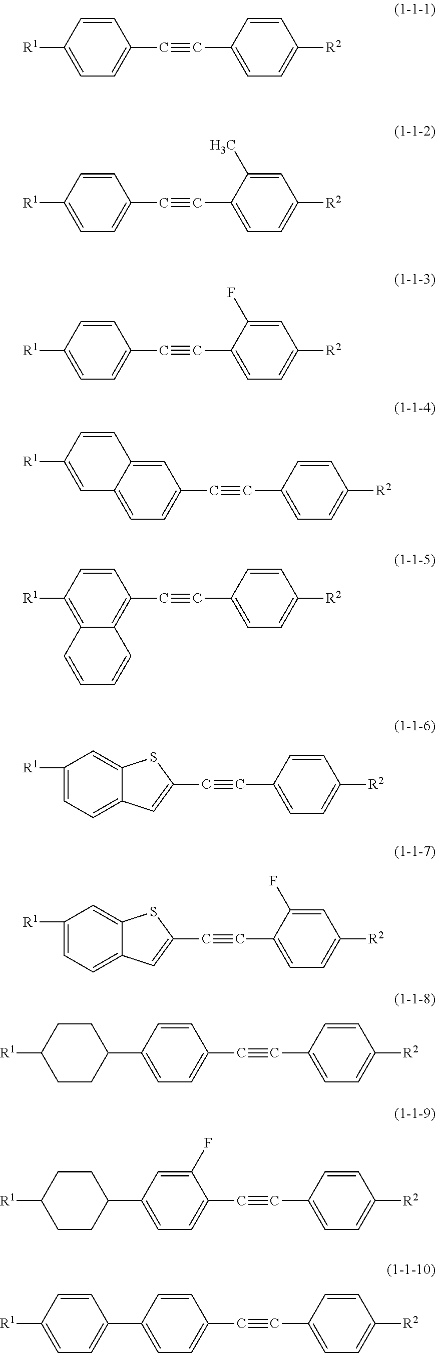 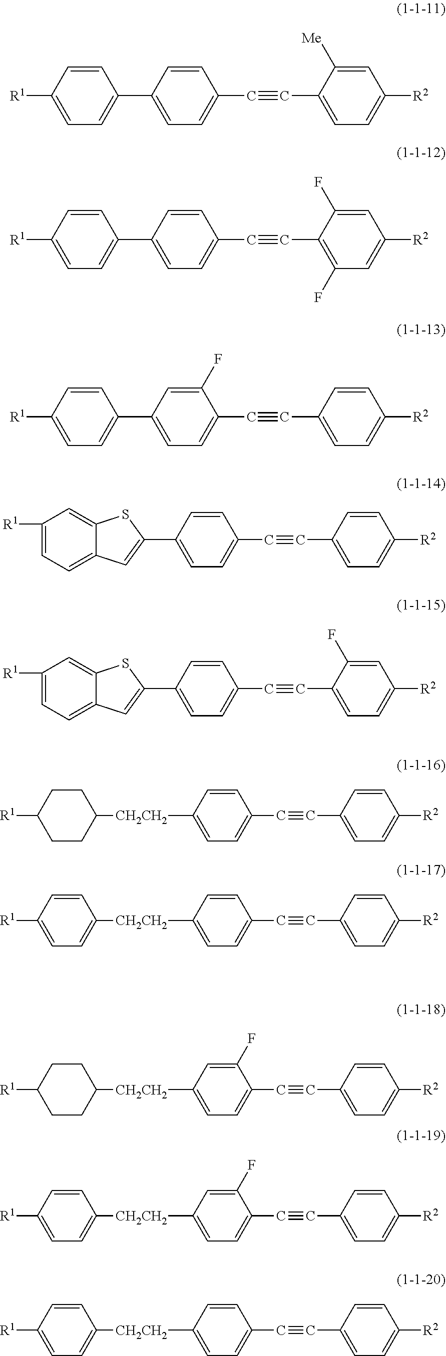 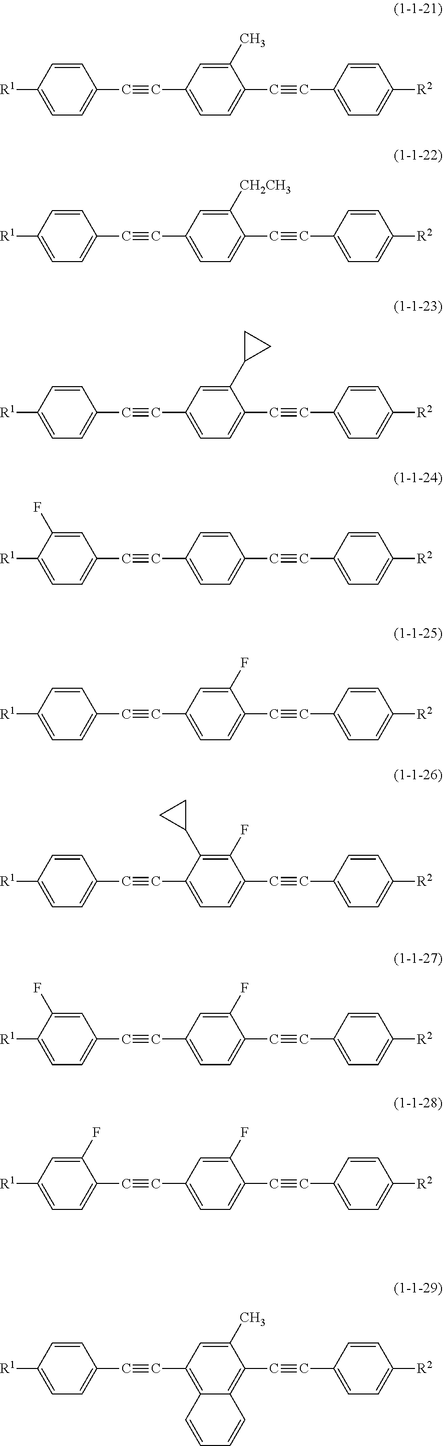 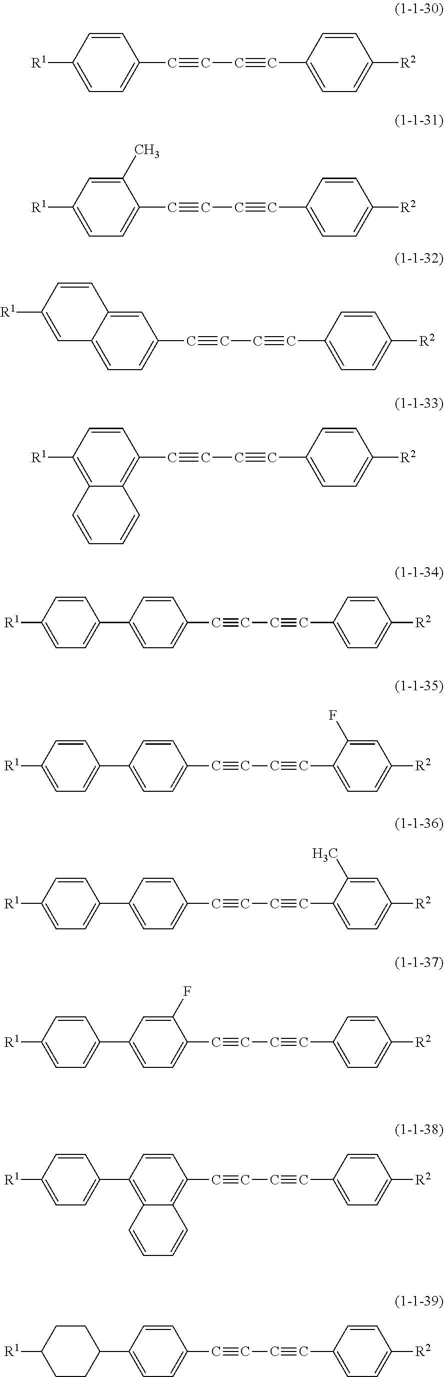 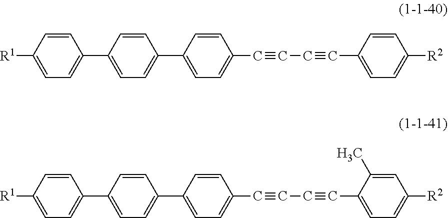
in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R² represents the above R¹, —CN, —F, —Cl, —CF₃, —OCF₃, —CF₂H, —OCF₂H, —NCS, or —SF₅.

10. The element according to claim 7, wherein the compound represented by Formula (1-2) is one selected from among compounds represented by the following Formula (1-2-1) to Formula (1-2-24): 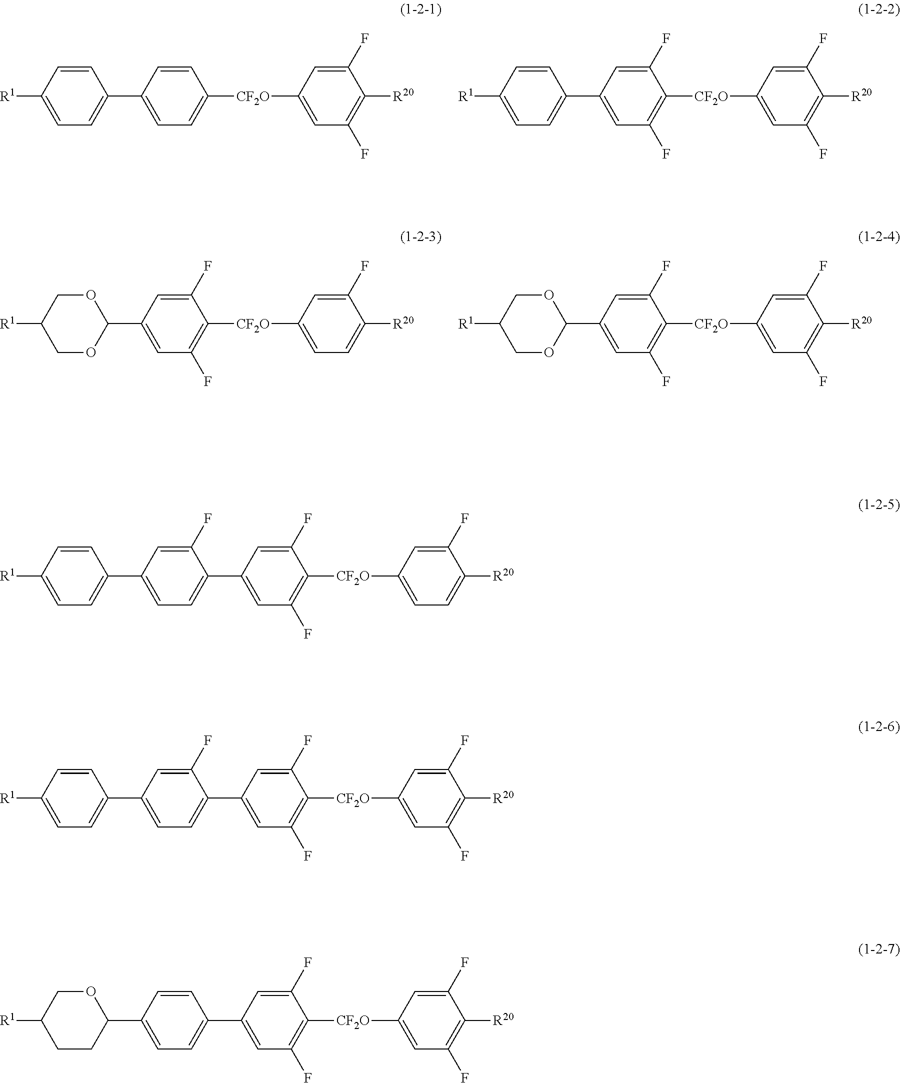 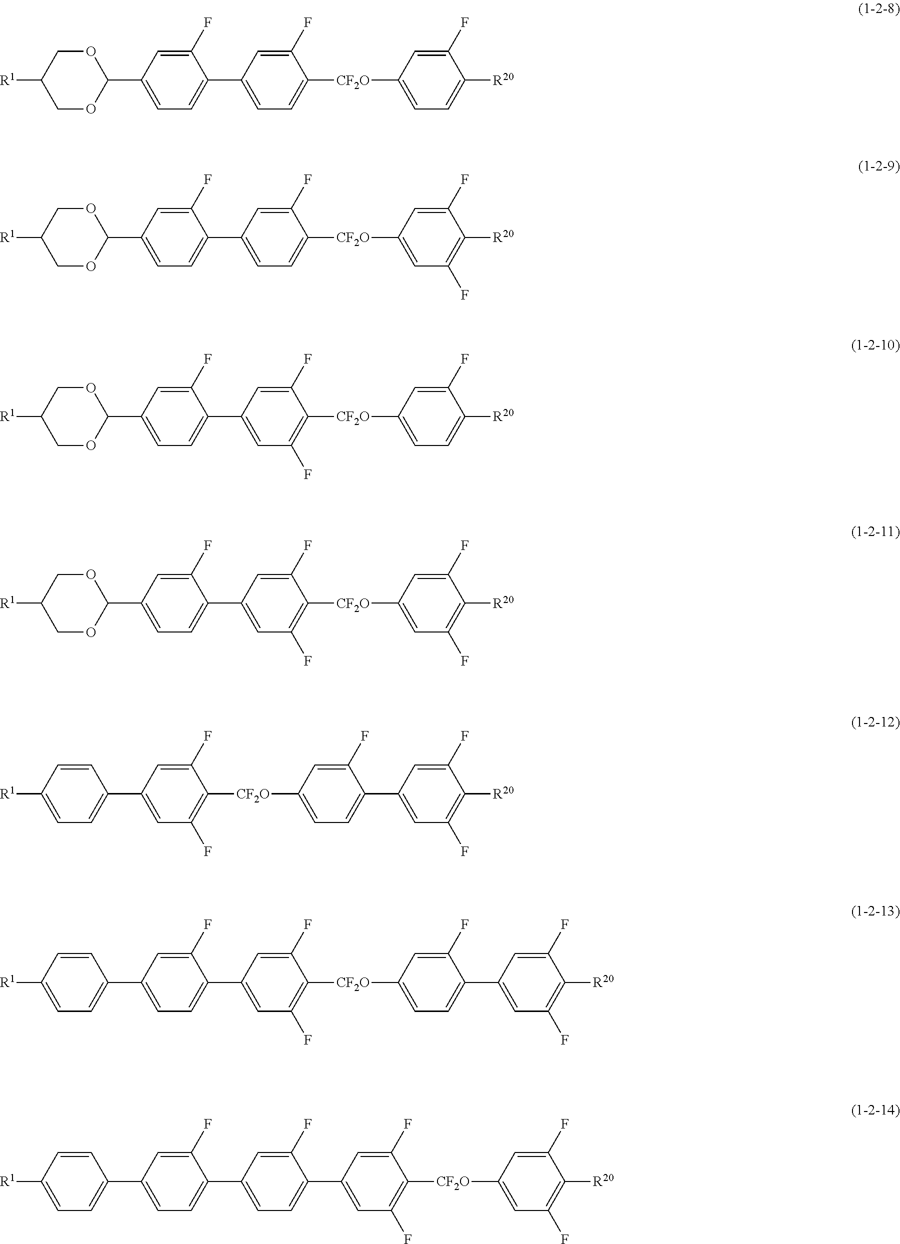 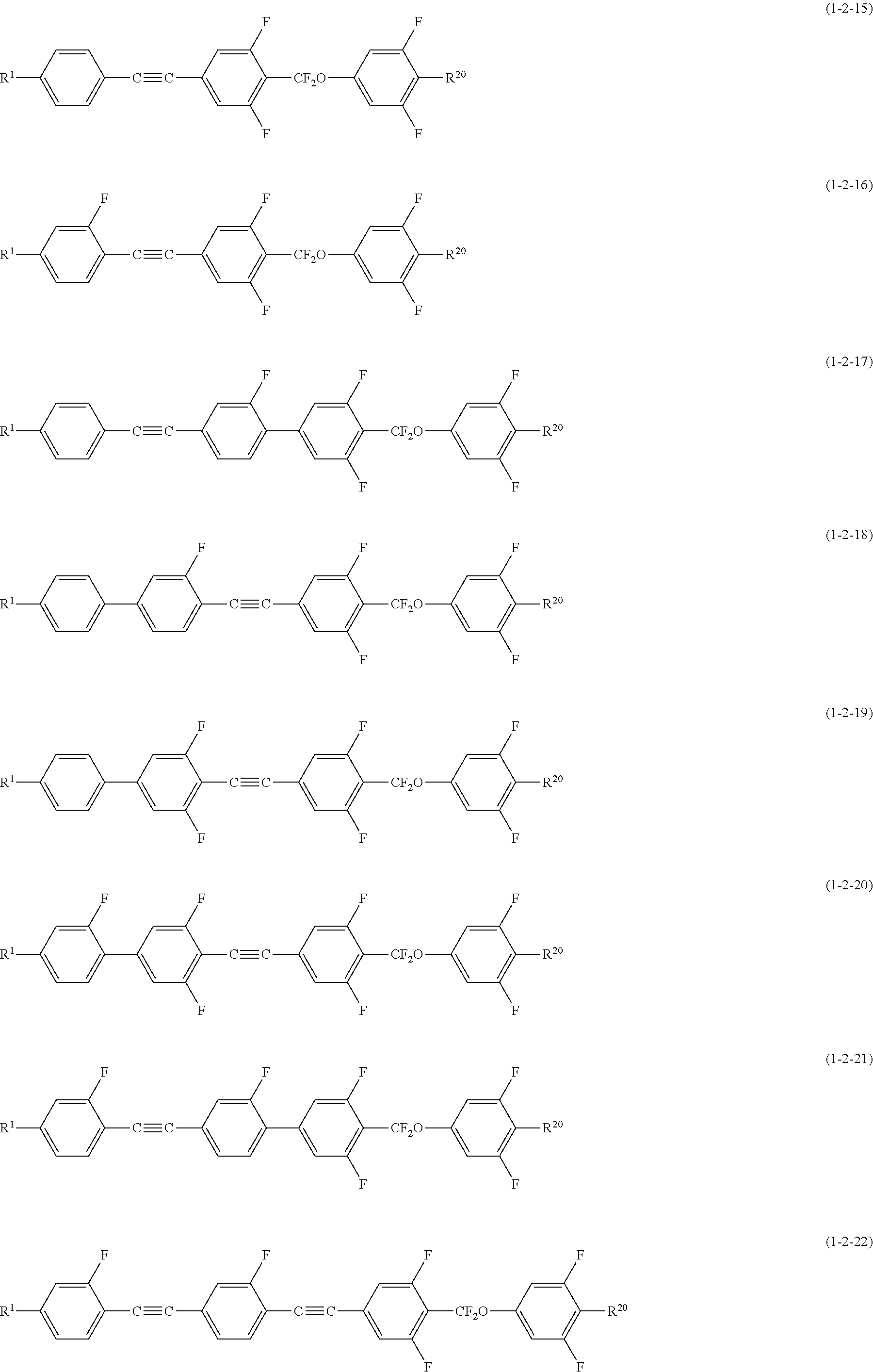 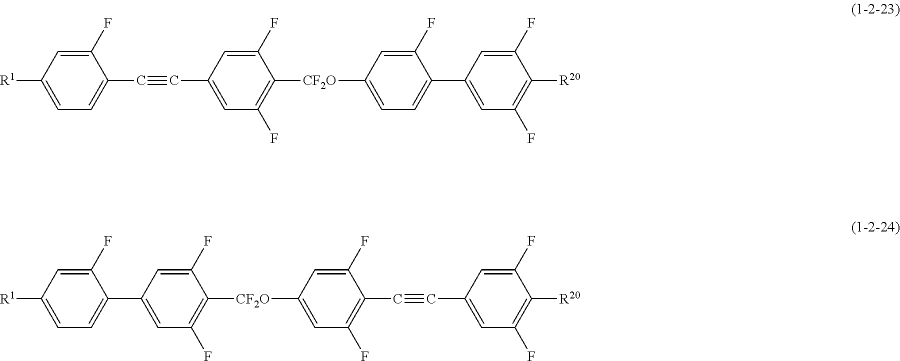
in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R²⁰ is —CN, —F, —Cl, —CF₃, —OCF₃, —CF₂H, —OCF₂H, —NCS, or —SF₅.

11. The element according to claim 8, wherein the compound represented by Formula (1-3) is one selected from among compounds represented by the following Formula (1-3-1) to Formula (1-3-42): 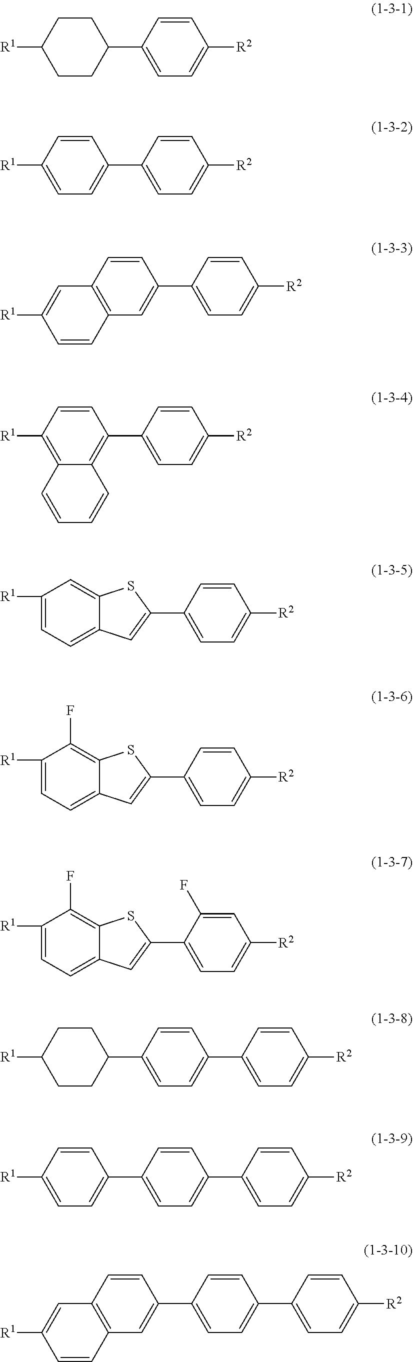 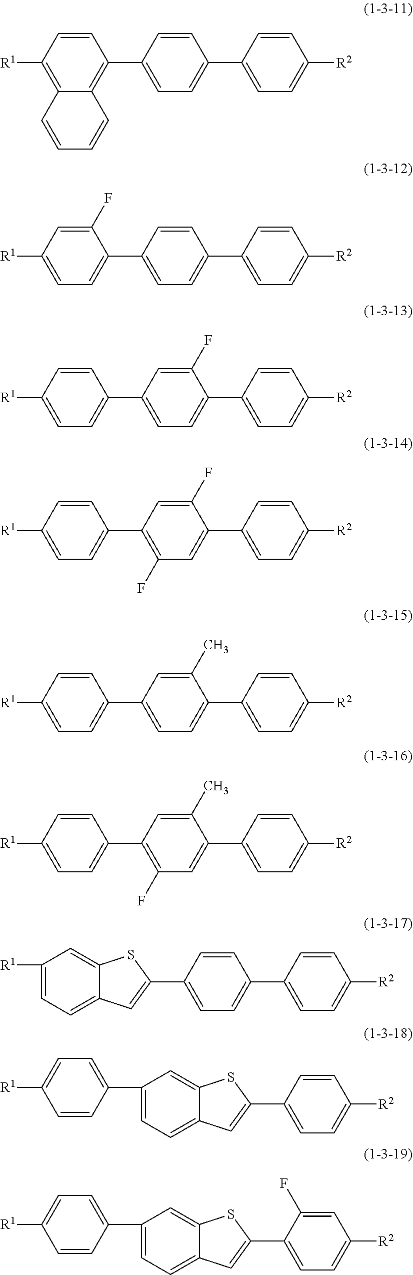 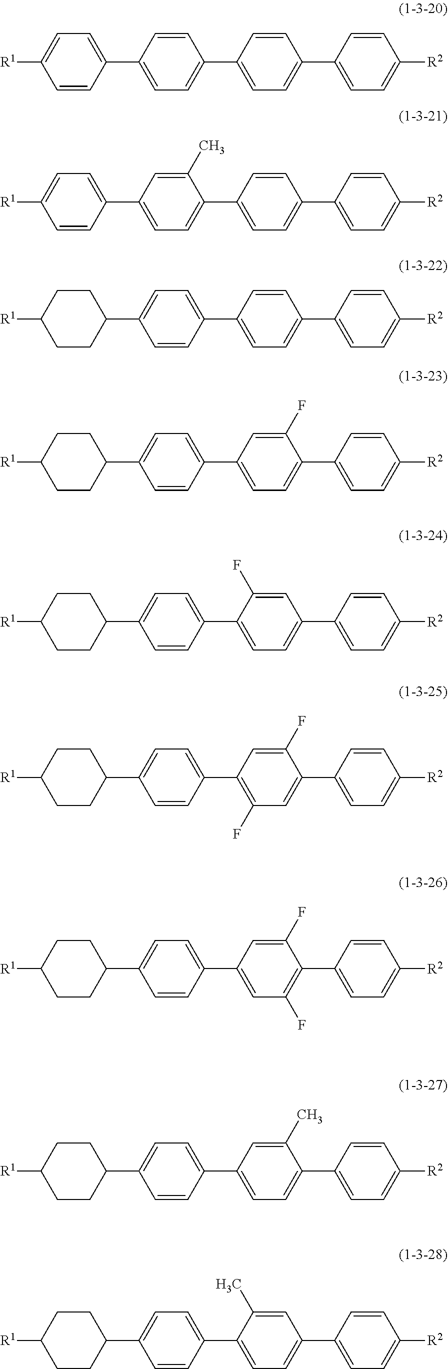 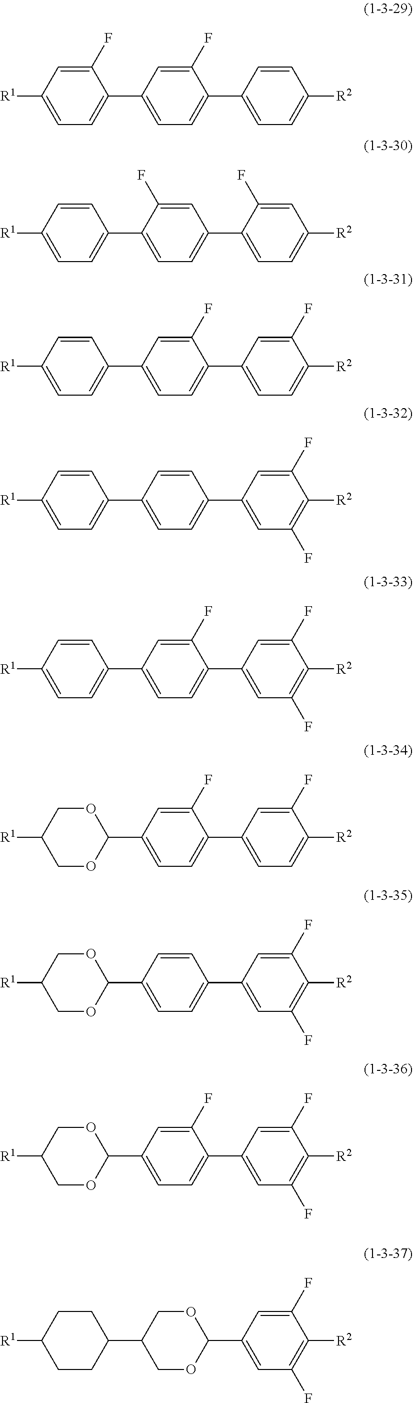 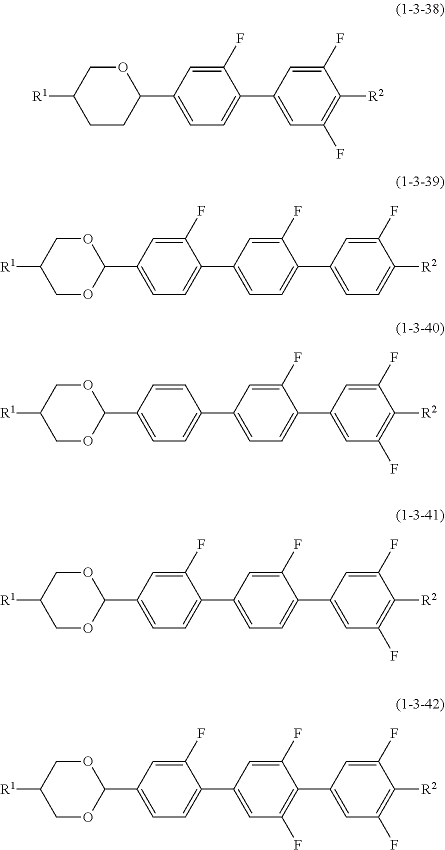
in these formulae, R¹ represents an alkyl group having 1 to 12 carbon atoms, an alkoxy group having 1 to 12 carbon atoms, an alkenyl group having 2 to 12 carbon atoms, or an alkynyl group having 2 to 12 carbon atoms, non-adjacent —CH₂— in R¹ may be substituted with —O— or —S—, and a hydrogen atom may be substituted with a fluorine atom; and R² represents the above R¹, —CN, —F, —Cl, —CF₃, —OCF₃, —CF₂H, —OCF₂H, —NCS, or —SF₅.

12. The element according to claim 6, wherein the liquid crystal composition is a composition including a proportion of 20 weight % to 80 weight % of the compound represented by Formula (1-1) and a proportion of 20 weight % to 80 weight % of the compound represented by Formula (1-2) or the compound represented by Formula (1-3) with respect to the total weight of the liquid crystal composition.

13. The element according to claim 1, wherein the liquid crystal composition is a composition including a proportion of 10 weight % or more of the compound in which R² is —CN or —NCS in the compound of Formula (1) with respect to the total weight of the liquid crystal composition.

14. The element according to claim 1, wherein the liquid crystal composition further contains a dichroic dye.

15. The element according to claim 1, wherein the polyimide alignment film is a polyimide film formed by firing an alignment agent containing polyamic acid.

16. The element according to claim 1, wherein the polyimide alignment film is a polyimide film formed by firing an alignment agent composed of a mixture of polyamic acid and a soluble polyimide or polyamic acid ester.

17. The element according to claim 15, wherein the polyimide alignment film is a polyimide film formed by firing an alignment agent additionally containing a silane coupling agent.

18. The element according to claim 15, wherein the polyimide alignment film is a polyimide film formed by firing an alignment agent additionally containing an epoxy compound.

19. The element according to claim 15, wherein the polyimide alignment film is a polyimide film formed by firing an alignment agent additionally containing an anti-rust agent.

20. The element according to claim 15, wherein the polyimide alignment film is rubbed.

21. The element according to claim 15, wherein the polyimide alignment film is subjected to an optical alignment treatment.

22. The element according to claim 15, wherein the polyimide alignment film is formed on copper or aluminum.
